(19) United States
(12) Patent Application Publication
(10) Pub. No.: US 2025/0377864 A1
(43) Pub. Date: Dec. 11, 2025

(54) LANGUAGE-MODEL-BASED CODE REQUIREMENT AUTOMATION

(71) Applicant: NVIDIA Corporation, Santa Clara, CA (US)

(72) Inventors: Yogesh DANGI, Pune (IN); Shrinidhi KOTA SHREESHAPURANIK, San Jose, CA (US); Alban DOUILLET, Monte Sereno, CA (US); Hamed JOODAKI, Fort Worth, TX (US)

(73) Assignee: NVIDIA Corporation, Santa Clara, CA (US)

(21) Appl. No.: 18/735,989

(22) Filed: Jun. 6, 2024

(51) Int. Cl. G06F 8/33; G06F 8/35; G06F 40/40

(52) U.S. Cl. CPC G06F 8/33; G06F 8/35; G06F 40/40

(57) ABSTRACT

Various examples, systems, and methods are disclosed relating to a computer system that can be designed for software development. The computer system can identify or access written details about the requirements for a software product. Using these requirements, the computer system can generate prompts that guide the operation of the software. The computer system can use the prompts and the initial requirements to produce feedback through a neural network, such as a large language model. The neural network can be trained with examples of software requirements and corresponding feedback. The feedback can suggest changes or confirm the requirements. Additionally, the computer system can provide the feedback, used for refining and improving software requirements.

### BACKGROUND

Software requirements, when articulated through natural language, can serve as foundations for software development processes. However, capturing precise and unambiguous requirements is inherently difficult due to language variability and subtlety of human language, leading to errors like ambiguities or unclear expressions. Processing requirements for accuracy demands significant computational resources, hindering efficiency, such as in real-time or near real-time environments. These challenges impede the effectiveness of systems in managing the complexities of software requirement specifications and ultimately affect the quality and reliability of the software products developed.

### SUMMARY

Implementations of the present disclosure relate to modeling software requirements specified in natural language or other input. In contrast to conventional systems, such as those that exhibit limitations in scalability and adaptability in processing natural language, the systems and methods described herein can address these limitations through various modeling techniques. This implementation provides more accurate interpretation and validation of requirements against defined standards. For example, the systems and methods can automatically detect and correct ambiguities and non-compliance issues, improving the clarity and reliability of software specifications. Furthermore, by using adaptive models and dynamic frameworks, the systems and methods can remain effective even as standards change. This provides improved systems and methods for managing software requirements across diverse application areas.

At least one implementation relates to one or more processors. The one or more processors can include one or more circuits that can be used to retrieve text representative of one or more requirements for a software product. The one or more circuits can generate, based at least on one or more criteria for operation of the software product, a prompt representative of the one or more criteria. The one or more circuits can cause a neural network, based at least on the text and the prompt, to generate feedback regarding the one or more requirements, the feedback including at least one of an indication of a modification of the text or the modification of the text, the neural network configured based at least on training data including a plurality of examples of requirements and a plurality of examples of feedback corresponding to the examples of requirements. The one or more circuits can output the feedback regarding the one or more requirements.

In some implementations, the one or more circuits can select the one or more criteria responsive to an input indicative of the one or more criteria. In some implementations, the plurality of examples of feedback can include a first example of feedback indicating that a first example of requirements of the plurality of examples of requirements meets a first criterion of the one or more criteria. Further, the plurality of examples of feedback can include a second example of feedback indicating that a second example of requirements of the plurality of examples of requirements does not meet the first criterion. Further, the plurality of examples of feedback can include a third example of feedback indicating that a third example of requirements of the plurality of examples of requirements meets a second criterion of the one or more criteria. Further, the plurality of examples of feedback can include a fourth example of feedback indicating that a fourth example of requirements of the plurality of examples of requirements does not meet the second criterion.

In some implementations, the configuration of the neural network using the training data can include a prompt tuning of the neural network, wherein prompt tuning includes updating a set of parameters of the neural network based on one or more annotations of the plurality of examples of requirements or the plurality of examples of feedback. In some implementations, the neural network can include one or more language models, the one or more language models updated/trained using natural language processing (NLP) to model the one or more requirements and generate the feedback. In some implementations, the neural network can include a transformer architecture, the transformer architecture transforming the prompt representative of the one or more criteria into the feedback in a human-readable format.

In some implementations, the text is a first text, the prompt is a first prompt, and the feedback is a first feedback, and the one or more circuits can retrieve a second text subsequent to output of the first feedback. The one or more circuits can generate, based at least on the one or more criteria, a second prompt representative of the one or more criteria. The one or more circuits can cause the neural network, based at least on the first feedback, the second text, and the second prompt, to generate a second feedback regarding the second text.

In some implementations, the prompt can be further generated based on a feedback level, the feedback level causes the neural network to generate the feedback according to predefined compliance of the feedback level. In some implementations, the indication of the modification of the text or the modification of the text satisfies the predefined compliance, and wherein the training data can include a plurality of feedback level examples corresponding with the plurality of examples of requirements and the plurality of examples of feedback.

At least one implementation relates a system including one or more processors to execute operations. The one or more processors can execute operations to retrieve text representative of one or more requirements for a software product. The one or more processors can execute operations to generate, based on one or more criteria for operation of the software product, a prompt representative of the one or more criteria. The one or more processors can execute operations to cause a neural network, based at least on the text and the prompt, to generate feedback regarding the one or more requirements, the feedback including at least one of an indication of a modification of the text or the modification of the text, the neural network configured based on training data including a plurality of examples of requirements and a plurality of examples of feedback corresponding to the examples of requirements. The one or more processors can execute operations to output the feedback regarding the one or more requirements.

In some implementations, the one or more processors executing the operations can select the one or more criteria responsive to an input indicative of the one or more criteria. In some implementations, the plurality of examples of feedback can include a first example of feedback indicating that a first example of requirements of the plurality of examples of requirements meets a first criterion of the one or more criteria. In some implementations, the plurality of examples of feedback can include a second example of feedback indicating that a second example of requirements of the plurality of examples of requirements does not meet the first criterion. In some implementations, the plurality of examples of feedback can include a third example of feedback indicating that a third example of requirements of the plurality of examples of requirements meets a second criterion of the one or more criteria. In some implementations, the plurality of examples of feedback can include a fourth example of feedback indicating that a fourth example of requirements of the plurality of examples of requirements does not meet the second criterion.

In some implementations, the configuration of the neural network using the training data can include a prompt tuning of the neural network, wherein prompt tuning includes updating a set of parameters of the neural network based at least on one or more annotations of the plurality of examples of requirements or the plurality of examples of feedback. In some implementations, the neural network can include one or more language models, the one or more language models updated/trained using natural language processing (NLP) to model the one or more requirements and generate the feedback, and wherein the neural network includes a transformer architecture, the transformer architecture transforming the prompt representative of the one or more criteria into the feedback in a human-readable format.

In some implementations, the text is a first text, the prompt is a first prompt, and the feedback is a first feedback, and the one or more processors executing the operations can retrieve a second text subsequent to output of the first feedback. The one or more processors can generate, based at least on the one or more criteria, a second prompt representative of the one or more criteria. The one or more processors can cause the neural network, based at least on the first feedback, the second text, and the second prompt, to generate a second feedback regarding the second text. In some implementations, the prompt can be further generated based on a feedback level, the feedback level causes the neural network to generate the feedback according to predefined compliance of the feedback level. In some implementations, the indication of the modification of the text or the modification of the text satisfies the predefined compliance, and wherein the training data includes a plurality of feedback level examples corresponding with the plurality of examples of requirements and the plurality of examples of feedback.

At least one implementation relates to a method. The method can include retrieving, using one or more processors, text representative of one or more requirements for a software product. The method can include generating, using the one or more processors based on one or more criteria for operation of the software product, a prompt representative of the one or more criteria. The method can include causing, using the one or more processors, a neural network, based at least on the text and the prompt, to generate feedback regarding the one or more requirements, the feedback including at least one of an indication of a modification of the text or the modification of the text, the neural network configured based on training data including a plurality of examples of requirements and a plurality of examples of feedback corresponding to the examples of requirements. The method can include outputting, using the one or more processors, the feedback regarding the one or more requirements.

In some implementations, the method can include selecting, using the one or more processors, the one or more criteria responsive to an input indicative of the one or more criteria. In some implementations, the prompt can be further generated based on a feedback level, the feedback level causes the neural network to generate the feedback according to predefined compliance of the feedback level.

The processors, systems, and/or methods described herein can be implemented by or included in at least one of a system for generating synthetic data; a system for performing simulation operations; a system for performing conversational AI operations; a system for performing collaborative content creation for 3D assets; a system that includes one or more language models, such as large language models (LLMs); a system that includes one or more vision language models (VLMs); a system for generating or presenting virtual reality (VR) content, augmented reality (AR) content, and/or mixed reality (MR) content; a system for performing digital twin operations; a system for performing light transport simulation; a system for performing deep learning operations; a system implemented using an edge device; a system implemented using a robot; a system associated with an autonomous or semi-autonomous machine (e.g., an in-vehicle infotainment system); a system incorporating one or more virtual machines (VMs); a system implemented at least partially in a data center; or a system implemented at least partially using cloud computing resources.

### BRIEF DESCRIPTION OF THE DRAWINGS

The present systems and methods for language-model-based code requirement automation are described in detail below with reference to the attached drawing figures, wherein:

FIG. 1 is a block diagram of an example system for language model code requirement automation, in accordance with some embodiments of the present disclosure;

FIG. 2 depicts a dataflow diagram showing how code requirement automation is performed using inputs and prompts, in accordance with some embodiments of the present disclosure;

FIG. 3 is an example illustration of a training dataset for updating/training the language model, in accordance with some embodiments of the present disclosure;

FIG. 4 is an example illustration of a graphical user interface for providing input to the language model, in accordance with some embodiments of the present disclosure;

FIG. 5 is a flow diagram of an example of a method for generating feedback regarding one or more requirements, in accordance with some embodiments of the present disclosure;

FIG. 6 is a block diagram of an example content streaming system suitable for use in implementing some embodiments of the present disclosure;

FIG. 7 is a block diagram of an example computing device suitable for use in implementing some embodiments of the present disclosure;

FIG. 8 is a block diagram of an example data center suitable for use in implementing some embodiments of the present disclosure;

FIG. 9A is a block diagram of an example generative language model system suitable for use in implementing some embodiments of the present disclosure;

FIG. 9B is a block diagram of an example generative language model that includes a transformer encoder-decoder suitable for use in implementing some embodiments of the present disclosure; and

FIG. 9C is a block diagram of an example generative language model that includes a decoder-only transformer architecture suitable for use in implementing some embodiments of the present disclosure.

### DETAILED DESCRIPTION

This disclosure relates to systems and methods for automation of software requirement using language models, such as large language models (LLMs), vision language models (VLMs), multi-modal language models, and/or otherwise. Effective generation of software requires proper text/language-based definitions of the requirements for the software. However, as a language-based form of communication, such requirements can be subject to semantic and/or syntactic errors such as ambiguity, lack of clarity, or lack of compliance with overarching standards (e.g., performance criteria) for the use of the product containing the software. As an example, software products for safety-critical functions (e.g., autonomous or semi-autonomous vehicle operation) can be required to meet specific performance and/or reliability criteria, which need to be implemented in the form of language-based requirements for the development of the software; improper generation of the requirements can thus increase the likelihood of the software products not meeting their respective criteria.

Some systems can perform natural language operations, such as rules-based operations (e.g., keyword detection), to process requirements and identify errors and/or provide suggested modifications to the requirements based on the errors. However, such systems can lack the ability to scale beyond detection of errors from terms identified in programmed rules, or to be flexible or customizable to modifications in standards that the requirements are to be based on.

Software requirements, when articulated through natural language, are vulnerable to various issues due to the limitations of verbal communication. Requirements can exhibit semantic or syntactic errors, which include ambiguities or unclear expressions, potentially leading to non-compliance with necessary standards. This may be particularly problematic in domains requiring high reliability and performance, such as software for safety-critical functions. Moreover, current systems designed to process these requirements through natural language operations often exhibit limitations in scalability and lack the flexibility to adapt to changing standards. These limitations can impede the effectiveness of systems in addressing the complexities of software requirement specifications and management.

Systems and methods in accordance with the present disclosure can implement one or more language models (e.g., LLMs, VLMs, etc.) to allow for more effective processing, evaluation, modification, and/or feedback generation for language-based software requirements. Although the present disclosure is primarily described with respect to LLMs, this is not intended to be limiting, and any type of language model (e.g., LLM, VLM, multi-modal language model, etc.) may be used without departing from the scope of the present disclosure.

The systems and methods described herein can leverage the natural language processing capabilities of LLMs, for example, such as but not limited to semantic understanding capabilities, to allow for more flexible and/or scalable evaluation of requirements. The system can use specific model tuning techniques, such as prompt tuning (p-tuning), to more efficiently (in computational resources and/or time) configure the LLMs, such as based on training data including natural language (e.g., structured or unstructured text) examples of requirements and associated criteria having diverse features and corresponding review comments for the requirements. LLMs p-tuned on different tasks can be saved, without the need for large amounts of memory. As such, systems and methods in accordance with the present disclosure can facilitate more efficient generation of more accurate requirements, such allowing for real-time or near real-time feedback generation. This can allow for reduced resource usage in the software design, development, and testing process.

In some implementations, the system can use the language model to perform high-level evaluations such as automation of review, content coherence, language and grammar checking, consistency checking, and/or compliance with standards (e.g., Easy Approach to Requirements Syntax (EARS); Standards from International Council on Systems Engineering (INCOSE)). The use of language models can facilitate such functions to extend beyond the capabilities of other requirement evaluation tools.

The language model can be updated/trained on examples of requirements, associated criteria, and corresponding feedback and/or suggestions provided for the requirements and associated criteria. The examples of requirements and associated criteria can be selected to relate to a diverse range of requirements to prevent overfitting. The language model can be updated/trained using a p-tuning technique in which a prompting layer is configured to generate prompts to be combined with (e.g., prepended to) the input text from a user at runtime.

The system can include a user interface layer, module, or component to receive an input representative of one or more requirements (e.g., in text or other formats), and to provide responses regarding the requirements. The system can include an application programming interface (API) layer, module, or component to retrieve text from the input representative of the requirements (and criteria, query, and/or at least a portion of the software product), and to provide the text to a prompting layer, module, or component for the prompting layer to generate a prompt including the text and an instruction corresponding to one or more criteria (e.g., standards) for processing of the requirements. The prompt can be representative of the one or more requirements, the one or more criteria, a query, and/or at least a portion of the software product. The criteria can be selected for a given input. The system can include a p-tuned LLM model to generate feedback with respect to the prompt and based at least on the instruction. For example, the neural network can be caused to generate feedback to a query in view of the one or more requirements, the one or more criteria, the query, and/or at least the portion of the software product. The API layer, using the user interface layer can at least one of present the feedback or present a modification of the requirements and associated criteria generated using the feedback.

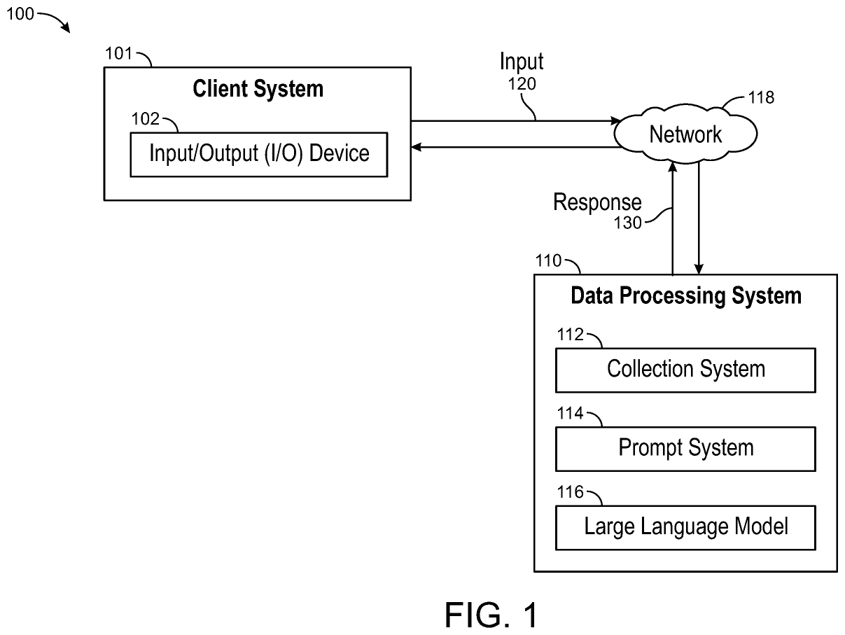

With reference to FIG. 1, an example computing environment including a system for large language model code requirement automation is shown, in accordance with some embodiments of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by entities can be carried out by hardware, firmware, and/or software. For instance, various functions can be carried out by a processor executing instructions stored in memory.

The system 100 is shown as including a client system 101, which can include one or more input/output device(s) 102. The client system 101 can include any type of device that is capable of communicating via a network 118, including but not limited to smartphones, laptop or mobile computers, personal computers, servers, cloud computing systems, or other types of computing systems that can generate or otherwise provide one or more inputs 120 to at least one data processing system 110. The client system 101 can include one or more communications interfaces that enable transmission of one or more network packets via the network 118 to one or more external computing systems, which can include the data processing system 110.

In one example, the client system 101 can include input/output devices 102 that receive user input. The user input can specify one or more inputs for a large language model (LLM, VLM, etc.) 116, in some implementations. For example, input 120 can be text representative of one or more requirements for a software product. In another example, the input 120 can be text representative of requirements, criteria, a query, and/or at least a portion of the software product. The text can be processed audio or speech, written text, images, structured data, or any other form of input data. In some embodiments, additional or alternative input types may be used, such as audio, video, images, 3D design files (e.g., CAD or universal scene descriptor (USD) files), etc. The input/output devices 102 can include touchscreen interfaces, display devices, a mouse, a keyboard, game controllers, haptic feedback devices, general purpose input devices, or other types of devices capable of providing input to generate one or more inputs 120. The input/output devices 102 of the client system 101 can include one or more display devices, audio output devices, or other output interfaces that provide a response 130 (e.g., output data) produced via a large language model 116 executed by the data processing system 110. For example, the input/output devices 102 of the client system 101 can include a display device capable of presenting notifications, messages, or output prompts of the response 130, according to the techniques described herein.

The system 100 is shown as including at least one network 118. The network 118 can include computer networks such as the Internet, local, wide, metro, or other area networks, intranets, satellite networks, other computer networks such as voice or data mobile phone communication networks, and combinations thereof. The collection system 112 of the data processing system 110 can communicate via the network 118, for instance with the client system 101. The network 118 can be any form of computer network that can relay information between the data processing system 110, the client system 101, and one or more information sources, such as web servers, external databases, or external computing systems, amongst others.

In some implementations, the network 118 can include the Internet and/or other types of data networks, such as a local area network (LAN), a wide area network (WAN), a cellular network, a satellite network, and/or other types of data networks. The network 118 can also include any number of computing devices (e.g., computers, servers, routers, network switches, etc.) that are configured to receive and/or transmit data within the network 118. The network 118 can further include any number of hardwired and/or wireless connections.

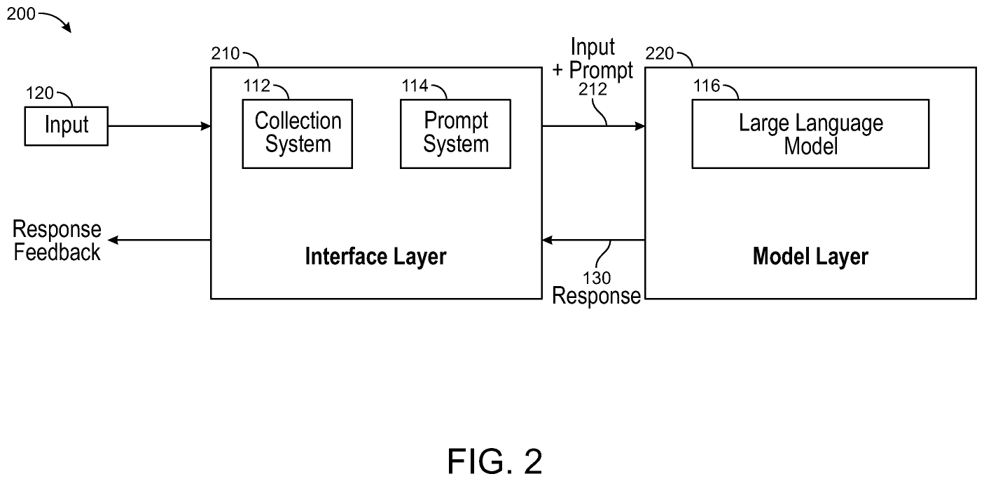

The system 100 is shown as including at least one data processing system 110, which can be in communication with the client system 101 via the network 118. The data processing system 110 can include one or more processors, circuits, memory, and/or computing devices/systems that can perform the various techniques described herein. The data processing system 110 described herein can be implemented, for example, in a cloud computing environment, which can maintain and execute one or more large language models 116. As shown, the data processing system 110 can include a collection system 110, a prompt system 114, and one or more large language models 116. In some implementations, the data processing system 110 can execute one or more of interface layer processes 210 of FIG. 2 in an interface layer, and can communicate with one or more external computing systems that maintain/execute model layer processes 220 of FIG. 2 in a model layer using one or more large language models 116.

As described herein, conventional approaches to software requirement creation and evaluation lack the technical precision needed to ensure clarity and compliance. Ambiguities and open-ended statements in requirements often lead to costly errors (e.g., critical bugs discovered late in the development process) and delays in software development (e.g., extended timelines due to misinterpretation of ambiguous requirements). To address these issues, the data processing system 110 can improve requirement review by using a large language model 116 to assess clarity, ambiguity, and adherence to industry standards.

For example, the collection system 112 can receive one or more inputs 120, which can be provided to the prompt system 114 to generate and provide a prompt to the large language model 116 representative of the one or more requirements, the one or more criteria, a query, and at least a portion of the software product. The prompt can be representative of the one or more requirements, the one or more criteria, a query, and/or at least a portion of the software product. The prompt can be provided with input 120. The input 120 and the one or more criteria can be modeled to facilitate the generation and refinement of software requirements. In some implementations, the data processing system 110 can include one or more input/output devices 102 and can receive one or more input 120 via user input to the data processing system 110. In some implementations, the inputs 120 can be maintained in the local memory of the data processing system 110.

For example, the one or more requirements can be functional requirements such as “The system must authenticate users using multi-factor authentication” or non-functional requirements like “The system must respond to user inputs within 2 seconds under peak load conditions.” In another example, the requirements can be interface requirements such as “The system must provide a user-friendly dashboard for monitoring system health” or performance requirements like “The system must maintain 99.99% uptime.” Furthermore, for example, the one or more criteria can be specific performance standards such as “The system must adhere to industry best practices for security” or regulatory standards like “The system must comply with applicable data protection laws.” In another example, the one or more criteria can be usability standards such as “The system must be intuitive for users with minimal training” or compatibility standards like “The system must be compatible with existing enterprise software.” Moreover, for example, the query can be a validation question such as “Does this requirement meet the defined security standards?” or “Is this requirement unambiguous and testable?” In another example, the query can be a feasibility question such as “Can this requirement be implemented within the current project timeline?” or a clarity question like “Is this requirement clearly understandable by all stakeholders?” Additionally, for example, the at least the portion of the software product can be an architectural component such as “user authentication module” or “database management subsystem.” In another example, the portion of the software product can be an integration component such as “API gateway” or a user-facing component like “dashboard interface.” Thus, the prompt can include a structured request such as “Evaluate the requirement ‘The system must authenticate users using multi-factor authentication’ for clarity, compliance with industry standards, and overall testability, in the context of the user authentication module.”

The prompt system 114 can generate prompts in response to receiving the input 120 and/or in response to receiving a command or message from the large language model 116. The prompt system 114 can be configured to generate and provide specific prompts to the large language model 116 during a training process of the large language model 116. These prompts can be provided to cause responses based on predefined criteria associated with software requirements. In some implementations, the prompt system 114 can customize the prompts according to a complexity of the requirement under review and the level of detail needed in the feedback, as determined by varying levels (e.g., predefined feedback levels such that the detail in the feedback and the specificity of the evaluation by the large language model 116 are matched to the complexity of the provided input and prompt).

In some implementations, the data processing system 110 can include a collection system 112. The collection system 112 can collect requirement text (e.g., input 120) from the client system 101. The requirement text can include software requirements for a software product. For example, the requirement text can be specifications and user stories. In another example, the requirement text can include functional and non-functional requirements.

In some implementations, the collection system 112 can receive collection input 120 by receiving an API request from the I/O device 102. The API request can include parameters and commands. For example, the parameters can include details like the type of requirements (functional, non-functional, specifications, user stories), the scope of the requirement review (e.g., full project or specific modules), or other contextual data that can be used by the collection system 112 to analyze and process the incoming requirement data correctly. In another example, the commands can include instructions to retrieve, store, and/or process data related to software requirements. For example, commands might instruct the collection system 112 to fetch some or all existing user stories related to a specific software module or compile feedback on these requirements.

The collection system 112 can retrieve or access the client system 101 to collect additional details for requirement refinement. The collection system 112 can be used to collect, retrieve, or access training data or perform run-time analysis of input 120. For example, the training data can be collected by the collection system 112 by compiling a plurality of examples of requirements and associated criteria, and a plurality of examples of feedback corresponding to these requirements and associated criteria. In another example, the input 120 can be retrieved by the collection system 112 by querying current software functionality issues or bugs. The input 120 can be text representative of one or more requirements for a software requirement. In another example, the input can be text representative of the one or more requirements, one or more criteria (e.g., performance standards, security protocols, usability guidelines), query (e.g., “Is this requirement testable?”, “Does this requirement comply with security standards?”, “Is this requirement clear and unambiguous?”), and at least a portion of the software product (e.g., user authentication module, data processing system, user interface component). For example, input 120 can be project deliverables.

The data processing system 110 can execute the large language model 116 using at least the input 120 and a prompt (e.g., generated by the prompt system 114) as input. Executing the large language model 116 can include tokenizing the raw text information of the input prompt 120 and processing the tokens through multiple embedding and/or transformer layers. The large language model 116 can use autoregressive language modeling to generate text sequentially. For example, the large language model 116 can predict the token in the sequence of input tokens and any tokens previously generated by the large language model 116 for that input prompt 120.

The large language model 116 can be any type of text-based or multimodality language model capable of processing natural language text input. The large language model 116 can be or include a transformer-based model (e.g., a generative pre-trained transformer (GPT) model). The large language model 116 can be or include a vision language model (VLM), in some implementations. The large language model 116 can include a tokenizer model or portion that converts raw text or media data into an encoded format (e.g., one or more tokens, or a “tokenized” format) that is compatible with the layers of the large language model 116. The large language model 116 can be configured to execute natural language processing (NLP) by applying multiple layers of neural networks that analyze and synthesize language based on learned patterns in data. These layers can be used to perform tasks such as syntactic parsing, semantic analysis, and context understanding.

For example, the large language model 116 can process visual inputs, such as screenshots or other visualizations generated using the code. A user can upload a screenshot of a graphical user interface (GUI) displaying a data entry form generated from the code. The large language model 116 can receive this visual input with the textual requirement for the data entry functionality. The large language model 116 can provide feedback on whether the visual design meets the requirement, identifying any discrepancies or suggesting improvements.

In another example, the large language model 116 can receive and process 3D models or CAD files generated from the code as part of the input. A user can submit a CAD model of a user interface component, such as a dynamically updated dashboard. The large language model 116 can receive the CAD model with the requirement for a user-friendly and interactive dashboard. The large language model 116 can provide feedback on the usability and compatibility of the design, suggesting modifications if necessary. The large language model 116 can also process visualizations like flowcharts or architectural diagrams generated from the code, using these as information to make a determination.

Executing the large language model 116 can include performing one or more sampling techniques, such as softmax sampling or top-k sampling, to select the next token from a probability distribution generated using the large language model 116. The large language model 116 can be executed iteratively, incorporating previously generated tokens as context for generating subsequent tokens, until a termination condition has been reached. One type of termination condition can be a context length limit or a configurable limit on the number of tokens that can be generated and/or processed by the large language model 116. In some implementations, the termination condition can be satisfied when the large language model 116 generates a token that represents the end of a response to the input 120 and prompt. The large language model 116 can be trained/updated to be a conversational agent. For example, the large language model 116 can generate realistic natural language in response to natural language input.

In some implementations, the large language model 116 can be updated/trained using training data such as a plurality of examples of requirements and associated criteria, and a plurality of examples of feedback corresponding to the examples of requirements. For example, a first example of feedback can indicate that a first example of requirements of the plurality of examples of requirements meets a first criterion of the one or more criteria (e.g., an associated criteria). In this example, the first criterion can be an unambiguous criteria (e.g., software requirement must lend itself to a single interpretation). Additionally, the first example of requirements can be “System must encrypt data.” In another example, a second example of feedback can indicate that a second example of requirements of the plurality of examples of requirements does not meet the first criterion. In this example, the second example of requirements can be “User data should be secured.” In yet another example, a third example of feedback can indicate that a third example of requirements of the plurality of examples of requirements meets a second criterion of the one or more criteria (e.g., an associated criteria). In this example, the second criterion can be a verifiable criteria (e.g., software requirement must be verifiable). Additionally, the third example of requirements can be “API responses must be returned within 300 ms.” In yet another example, a fourth example of feedback can indicate that a fourth example of requirements of the plurality of examples of requirements does not meet the second criterion. In this example, the third example of requirements can be “System should scale based on user load.”

The large language model 116 can be updated by the prompt system 114 providing prompts representative of one or more criteria for operation of a software product. The prompts can be used to update or guide the operations of the large language model 116. The prompt system 114 can generate prompts representative of one or more one or more requirements, the one or more criteria, a query, and/or at least a portion of the software product by extracting phrases and operational benchmarks from the requirements. That is, the input can be text representative of the one or more requirements (e.g., <requirement1>, <requirement2>, etc.), one or more criteria (e.g., <criterion1>, <criterion2>, etc.), query (e.g., <query1>, <query2>, etc.), and at least a portion of the software product (e.g., <software component1>, <software component2>, etc.). In some implementations, the input can be in the form of “<query> . . . <requirement1> . . . ><criterion1> . . . <software component>”. Various alternatives can include different orders or combinations of requirements, criteria, queries, and software components such as “<query> . . . <criterion1> . . . <requirement1> . . . <software component>” or “<requirement1> . . . <query> . . . <software component> . . . <criterion1>”. For example, a prompt representative of one or more requirements and/or criteria can be “Verify that data encryption conforms to AES-256.” In some implementations, one or more requirements for a software product can be provided with one or more criteria for operation of the software product. For example, the software product can be a mobile banking application and the one or more requirements can be “Ensure all client-server communications are encrypted,” and the one or more criteria can be “Must use TLS 1.3 or higher.” In another example, the software product can be a cloud storage service and the one or more requirements can be “Data must be accessible globally within seconds,” and the one or more criteria can be “Global latency under 500 ms.”

With reference to the first example of feedback above, a first prompt representative can be “Evaluate if ‘System must encrypt data’ satisfies the unambiguous criterion.” With reference to the second example of feedback above, the first prompt representative can be “Assess whether ‘User data should be secured’ is specific and unambiguous.” With reference to the third example of feedback above, a third prompt representative can be “Confirm API responses must be returned within 300 ms meets the verifiability criterion.” With reference to the fourth example of feedback above, a fourth prompt representative can be “Determine if ‘System should scale based on user load’ can be quantified and verified.”

In some implementations, the large language model 116 can be a neural network. The data processing system 110 can configure (e.g., and without limitation, train, update, fine-tune) the neural network based on (iterative) evaluation of accuracy of the large language model 116 with respect to interpreting requirement prompts (e.g., relative to the training data). The neural network parameters can be updated/trained by applying gradient optimization on loss functions derived from training data. That is, the one or more requirements and one or more criteria for operation of a software product can guide the adjustment of model weights to focus on certain operational parameters (e.g., security standards, performance metrics, compliance checks, scalability and load handling, ambiguity and specificity in requirements, etc.). In some implementations, the training of the large language model 116 can include simulating different compliance scenarios. In one aspect, training includes integrating third-party compliance checks into the model's decision-making process. For example, the large language model 116 can be updated/trained by incorporating compliance standards (e.g., Easy Approach to Requirements Syntax (EARS); Standards from International Council on Systems Engineering (INCOSE)). For example, the compliance standards can be the one or more criteria.

During the training phase, the large language model 116 (and/or a second model coupled with the large language model 116) can use natural language processing (NLP) to analyze and/or learn from text data (e.g., identifying the semantic and syntactic structure of software requirements). NLP techniques can be used by the large language model 116 to parse text, extract patterns, and understand the context of language used in the requirements. That is, the model can be updated/trained with a large amount of text that includes various forms of software documentation and feedback annotations. The large language model 116 can apply algorithms such as tokenization, part-of-speech tagging, and named entity recognition to preprocess the text data. These processed inputs can then be fed into the neural network, which can use layers of transformers to generate embeddings that capture the relationships and meanings of words within the context of software requirements. In some implementations, the large language model 116 can adjust its parameters through backpropagation based on the accuracy of its output compared to expected results (e.g., as represented by the training data).

In some implementations, the large language model 116 can be updated/trained using prompt tuning (sometimes referred to as “p-tuning”). Prompt tuning can include using a specific subset of the model's parameters and update the parameters based on the training data composed of examples of requirements and corresponding feedback. For example, the prompt tuning process could include training with input in combination with prompts such as “verify that the requirement includes use of GPU acceleration for computational tasks.” In this example, this can include training the model on software requirements that specify the inclusion of GPU technology.

For example, prompt tuning can include updating one or more parameters (or set of parameters) of the neural network of the large language model 116 based on one or more annotations of the plurality of examples of requirements and associated criteria, or the plurality of examples of feedback. For example, an annotation could be “Requirement does not specify encryption method, lacks detail needed for unambiguity.” In another example, an annotation could be “Feedback notes that the requirement for API response time is well-defined and measurable, confirming verifiability.”

The feedback associated with each requirement example can indicate whether the requirement example meets certain predefined criteria, such as unambiguity or verifiability. That is, the large language model 116 can adjust the response 130 during training to better analyze and interpret the software requirements. For example, if a requirement is provided as “The user interface should be easy to use,” the large language model 116 could model this input to determine whether this statement is too subjective and suggest more precise language. In this example, the functionality of the large language model involves the processing and interpretation of software requirements with criteria (e.g., prompts). However, prompt tuning can be used to specifically target the adjustment of response patterns. In some implementations, prompt tuning is applied to further refine the large language model 116's performance by using feedback loops from the examples of requirements and associated criteria. For example, if feedback indicates that a particular requirement does not meet the “unambiguous” criterion, large language model 116, through prompt tuning, adjusts to improve recognition and flag similar instances in future assessments. The iterative training process, which can be based on specific feedback relating to criteria, improves large language model 116 performance in performing software requirements validation. For example, if the large language model 116 detects the requirement “System response time shall be fast,” it can prompt to client system 101 (e.g., through response 130) for a quantifiable definition of “fast.”

In some implementations, the training process for the large language model 116 can include providing specific examples and prompts that simulate software requirement assessments as input (e.g., by the prompt system 114). The prompts can be generated by the prompt system 114 to test the large language model 116's training and accuracy of modeling requirement statements. The prompts can also be generated to test the large language model 116's accuracy of feedback used to further tune the large language model 116. For example, the large language model 116 can receive a prompt to evaluate whether a requirement such as, “The system shall refresh data every 10 seconds,” meets the criteria for verifiability and unambiguity.

In some implementations, the training of the large language model 116 incorporates predefined levels such as L0, L1, L2, L3, (collectively referred to as “feedback levels”) which can be used to specify the complexity of feedback during the prompt tuning process. The levels can be used by the prompt system 114 in selecting the complexity of the prompts that are presented to the model. At level L0, the prompt might include a basic verification of the requirement's clarity, while at level L1, the prompt might assess both clarity and basic compliance with given standards. Levels L2 and L3 can relate to progressively more complex assessments, having the large language model 116 perform detailed compliance with standards such as EARS and INCOSE. The prompt system 114 can select or provide various levels during training with the plurality of examples of requirements and associated criteria, and the plurality of examples of feedback.

In some implementations, the operational functionality of the large language model 116 is improved through the use of levels during training. The prompt system 114 can generate prompts that correspond to the designated level, which can influence the specificity and complexity of the large language model 116's output. For example, a level L2 prompt might request the large language model 116 to analyze a software requirement against industry-specific benchmarks or regulatory compliance issues. In another example, a Level L1 prompt can require the large language model 116 to verify the explicitness of a requirement statement, while a Level L3 prompt could include analyzing the requirement against performance and security criteria specified in external standards. By assigning feedback levels to prompts, the prompt system 114 can provide targeted training to the large language model 116.

In some implementations, the selection of the feedback level during training can be guided by the level of feedback desired or requested by the prompt system 114. The prompt system 114 can select a level based on the complexity of the software requirement and how much analysis should be applied. The levels can be used to determine how detailed the feedback should be (e.g., clarity check, detailed compliance assessments with industry standards, etc.) The prompt system 114 can determine the specific level—ranging from L0 to L3 (or higher)—based on the complexity of the software requirement and the depth of analysis needed to validate the requirement against predetermined requirements and/or criteria. For example, for basic requirement checks, the prompt system 114 can select Level L0, which can focus training on the clarity of the requirement statement. In another example, for more complex requirements that include compliance with specific industry standards or functional specifications, Level L3 can be selected. This level can require the large language model 116 to perform an analysis that verifies that the requirement adheres to all specified criteria, such as external compliance standards and performance benchmarks.

In a run-time or production environment, the prompt system 114 can be configured to process the text representative of software requirements retrieved by the collection system 112. The prompt system 114 can generate prompts that encapsulate the operational criteria for the software product's functionality. The prompt system 114 can determine the prompts for the large language model 116 to analyze and validate the requirements based on the operational criteria outlined. The prompt system 114 can send the prompts, along with the input 120 (text of the requirements), and/or a specified level for modeling, to the large language model 116. Furthermore, the prompt system 114 can vary the complexity of the generated prompts depending on the complexity of the input or requested feedback. By including both the requirement text and a prompt, with a designated feedback level, the prompt system 114 can improve the large language model 116.

In some implementations, the large language model 116 can be deployed into an operational environment where it can be configured to receive inputs and generate outputs relevant to the evaluation of software requirements. This process can be facilitated by the prompt system 114, which can prepare and provide structured prompts and inputs derived from the operational criteria of a software product. The prompts can be based at least on one or more requirements for a software product and one or more criteria related to the one or more requirements. These prompts can be generated to guide and improve the large language model 116's analysis and feedback generation. The prompts can be representative of the one or more requirements, the one or more criteria, a query, and/or at least a portion of the software product. The large language model 116 operates by processing these inputs using natural language processing (NLP) techniques to interpret, analyze, and generate responses 130 that assess the compliance, functionality, and clarity of software requirements.

Text data can be generated by detokenizing the tokens generated using the large language model 116 (e.g., using the tokenizer model associated with the large language model 116, etc.). Output text generated by the large language model 116 can be provided as part of the response 130. For example, output text can be feedback that can be presented to the user. The response 130 can include text data generated using the large language model 116. As described herein, the response 130 can include one or more requirements with an indication of a modification of the input 120 or a modification of the input 120. For example, the feedback can include at least one of an indication of a modification of the text or the modification of the text. The large language model 116 can replace or otherwise substitute the input 120 (e.g., representative of one or more requirements for a software product) with an indication (or suggestion) or a modification of the input 120. Tokenization, a process in NLP, segments text into tokens that the large language model 116 processes. The tokens provide structured input for generating accurate responses to the modifications or suggestions for the requirements described in the response 130.

The response 130 can be provided for display at the computing system that provided the input 120. For example, the response 130 can be provided as input to the client system 101 for display via the input/output device(s) 102. If the input 120 is received via input to the data processing system 110, the data processing system 110 can provide the response 130 via an output device of the data processing system 110.

In some implementations, the client system 101 can host or provide a user interface, which can be part of a UI layer, for users to input software requirements. This user interface can be used by users to interact with the data processing system 110, such as through a web page, desktop application, or mobile application. The UI layer can capture user input, verify the input conforms to expected formats, and transmit this data to the API layer for processing. In some implementations, an API layer can be employed within the data processing system 110, for example, managed by the collection system 112. The API layer can be a communication endpoint for the client system 101, accepting requirement texts submitted by users through the UI and preparing the inputs for modeling. The API layer can facilitate the encapsulation and decryption of data packets over the network 118. In some implementations, the API layer operated by the collection system 112 can prepare the data for subsequent stages of analysis and modeling. In some implementations, a prompt layer can be a software component of the prompt system 114 that can format incoming requirement texts into structured prompts suitable for analysis by the large language model 116. The prompt layer can receive the processed input from the API layer and enrich it with additional context or processing instructions used by the large language model 116 to perform improved modeling and analysis. The prompt layer can be used to generate the command set that the large language model 116 uses to generate feedback and suggestions.

Although primarily referred to as a layer herein, such as the API layer or the prompt layer, a layer may alternatively be referred to as a module, component, or other software or hardware element.

Referring now to FIG. 2, a dataflow diagram 200 showing how code requirement automation is performed using inputs and prompts, in accordance with some embodiments of the present disclosure. As shown, the data processing system 110 can execute an interface layer process 210 and a model layer process 220. At the interface layer process 210, the collection system 112 can retrieve or receive input 120 such as text representative of one or more requirements, one or more criteria, a query, and at least a portion of the software product. The prompt system 114 can process the input 120 and generate a prompt representative of the one or more requirements, the one or more criteria, a query, and/or at least a portion of the software product. The one or more criteria can be for operation of a software product corresponding with the input 120. For example, input 120 can be a software requirements document for a video game development project (e.g., software product). In this example, the prompt system 114 can generate a checklist verifying game mechanics and user interface requirements (e.g., prompt) that can include standards for gameplay fluidity, interface responsiveness, and compliance with online security regulations (e.g., criteria). In some embodiments, the prompt system 114 can apply or embed a feedback level that can cause the neural network to generate the response 130 according to predefined compliance of the feedback level. For example, the feedback level can be Level 3 for high complexity and detailed compliance verification. In this example, the input+prompt 212 can include the feedback level for modeling by the large language model 116.

In some embodiments, the output of the prompt system 114 can be generated based on the requirement collection process using a UI layer that can scrape files to develop the requirements, influenced by the level of feedback desired or requested (e.g., L0, L1, L2, L3). For example, the prompt system 114 can generate the output shown below based on an EARS compliance guideline. The output message from the prompt system 114 could be: “message=Context: A requirement should meet the below criteria. Unambiguous: Requirement must lend itself to a single interpretation. Some rules to follow: Use active voice, use defined terms, avoid adjectives and adverbs, repeat nouns in full instead of using pronouns. Singular: Requirement must address a single thought. Some rules to follow are write clear sentence(s), avoid combinators, avoid parenthesis, avoid phrases that indicate the purpose of the requirement. Verifiable: Requirement must be verifiable—The realization of the requirement can be proven (verified) to the customer's satisfaction at the level the requirement exists. Some rules to follow are write well-structured statement, use active voice, use defined terms, keep to a single sentence, ensure the requirement is constrained by testable limits such as system response time or QoS. Complete: Requirement statement must be a complete sentence and understandable by itself without depending on other statements to be understood in its basic form. Requirements set should cover types of Functional, Performance, Interface, and Security. Consistent: Requirements must be stated consistently without contradicting themselves. Some rules to follow are use consistent terminologies. Use a glossary, acronym list, abbreviation list. Trigger Words: The requirement should not contain negative imperative words, vague words, Optional Escape Clauses words, Optional Open-Ended Clauses, immeasurable quantification words, and Non-specific Temporal Words. The requirement should adhere to one of the following patterns. Ubiquitous: The <system name> shall <system response>. Event-Driven: When <trigger> <optional precondition>, the <system name> shall <system response>. Unwanted Behavior: If <unwanted condition or event>, then <system name> shall <system response>. State-Driven: While <system state>, the <system name> shall <system response>. Optional Feature: Where <feature is included>, the <system name> shall <system response>. Evaluate the below Requirement also give justification for not met criteria.” This output (e.g., the prompt), along with the input 120, can be provided to the large language model 116. In some embodiments, the input 120 can be incorporated into the prompt for processing, where the prompt can then be provided to the large language model 116.

As described above, the prompt system 114 can generate prompts that are formulated based on a requirement collection process and one or more criteria related to the one or more requirements, which can include using a UI layer to scrape relevant files. The criteria can be related in that they provide a framework for assessing the completeness, clarity, and/or compliance of the requirements. For example, the criteria may be performance benchmarks, security protocols, and usability standards, which can be related to requirements in that they define the expected behavior, safety measures, and user interactions of the software. As shown, a relationship can be established through the mapping of specific requirements to corresponding criteria, verifying that each requirement meets the various standards. The prompt system 114 can customize the content and structure of prompts according to specific EARS compliance guidelines or other standards, such that prompts can reflect the operational requirements and/or criteria for evaluating software requirements. The requirements and/or criteria selection within the prompts can be responsive to an input indicative of the desired requirements and/or criteria, providing dynamic adjustments based on the specific needs or feedback levels requested. The prompts can include instructions for creating requirements that are unambiguous, singular, verifiable, complete, and/or consistent, incorporating rules such as using active voice and defined terms, avoiding vague language, and verifying requirements are independently understandable. Additionally, the prompt can include trigger words to avoid and specific patterns that the requirements should follow.

At the model layer process 220, the large language model 116 can receive the input+prompt 212 as input, model the received data, and output a response 130. In some implementations, the large language model 116 can be a neural network such as a transformer architecture. The transformer architecture can transform the prompt representative of the one or more requirements and/or criteria into the feedback in a human-readable format-response 130. Furthermore, the large language model 116 can be updated/trained using natural language processing (NLP) to model the one or more requirements and generate the response 130. In some implementations, the response 130 can include an indication of a modification of the text or the modification of the text. For example, the indication of the modification of the text can be “Please revise the user authentication flow to include multi-factor verification.” In another example, the modification of the text can be updates to the software requirements document to specify encryption protocols more clearly.

In some implementations, the large language model 116 and the model layer process 220 output can be based on training data including a plurality of examples of requirements and associated criteria, and a plurality of examples of feedback corresponding to the examples of requirements and associated criteria. For example, the response 130 of the large language model 116 can be based on evaluations of compliance with software development standards. That is, model layer process 220 occurs after the large language model 116 is updated/trained and deployed to generate feedback to the query in view of the one or more requirements, the one or more criteria, and at least a portion of the software product. For example, causing the neural network to generate feedback to the query can include generating a response to “Is the requirement ‘The system must support 1000 concurrent users’ feasible given the current system architecture?” In another example, causing the neural network to generate feedback to the query can include generating a response to “Does the requirement ‘The system must encrypt all user data at rest and in transit’ comply with industry best practices?” In both examples, the feedback to the query can be a model output that identifies potential issues, suggests improvements, and/or provides justifications based on industry standards and best practices. In some examples, the response 130 can be provided as response feedback to the technical writing team for necessary updates to the project's documentation. In some examples, the response 130 can be provided as response feedback to the project management team for further assessment and action.

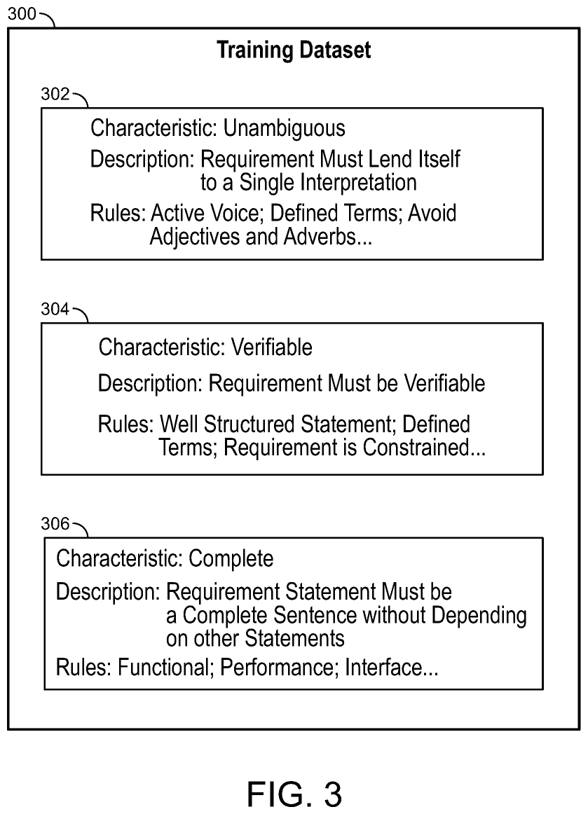

Referring now to FIG. 3, an example illustration of a training dataset 300 for updating/training the large language model, in accordance with some embodiments of the present disclosure. As shown, training dataset can include a plurality of data structures used in training the large language model 116. As shown, data structure 302 can include a software requirement characteristic (e.g., “Unambiguous”), a description of the characteristics (e.g., “Requirement must lend itself to a single interpretation”), and rule parameters (e.g., “Active voice; Defined terms; Avoid adjectives and adverbs . . . ”). Additionally, data structure 304 can also include a software requirement characteristic (e.g., “Verifiable”), a description of the characteristics (e.g., “Requirement must be verifiable”), and rule parameters (e.g., “Well-structured statement; Defined terms; Requirement is constrained . . . ”). In another example, data structure 306 can also include a software requirement characteristic (e.g., “Complete”), a description of the characteristics (e.g., “Requirement statement must be a complete sentence without depending on other statements”), and rule parameters (e.g., “Functional; Performance; Interface . . . ”).

In some implementations, the data structures 302-306 can be used to generate a prompt (e.g., by prompt system 114) representative of the one or more requirements, the one or more criteria, a query, and at least a portion of the software product in the data structures of training dataset 300. For example, a message could be: “Context: A requirement should meet below criteria. Unambiguous: Requirement must lend itself to a single interpretation. Some rules to follow: Use active voice, use defined terms, avoid adjectives and adverbs, repeat nouns in full instead of using pronouns. Verifiable: Requirement must be verifiable—The realization of the requirement can be proven (verified) to the customer's satisfaction at the level the requirement exists. Some rules to follow are write well-structured statement, active voice, defined terms, single sentence, ensure the requirement is constrained by testable limits such as system response time or QoS. Complete: Requirement statement must be a complete sentence and understandable by itself without depending on other statements to be understood in its basic form. Requirements set should cover types of Functional, Performance, Interface. Trigger Words: The requirement should not contain negative imperative words, vague words, Optional Escape Clauses words, Optional Open-Ended Clauses, immeasurable quantification words, and Non-specific Temporal Words. The requirement should adhere to one of the following patterns: Ubiquitous: The <system name> shall <system response>. Event-Driven: When <trigger> <optional precondition>, the <system name> shall <system response>. Unwanted Behavior: If <unwanted condition or event>, then <system name> shall <system response>. State-Driven: While <system state>, the <system name> shall <system response>. Optional Feature: Where <feature is included>, the <system name> shall <system response>. Evaluate the below Requirement also give justification for not met criteria.” In this example, the Requirement (e.g., input 120) could be “The system should load web pages within 3 seconds when the user has a high-speed internet connection.” In this example, both the prompt and the requirement could be passed as input, during updating/training or runtime, to the large language model 116. As shown, the input can include software requirements (e.g., generated for updating/training or provided in runtime) with a prompt to improve the model's output.

In some implementations, in response to providing the input, the large language model 116 could output a response providing feedback for the particular software requirement. For example, the output can be “Output: Unambiguous—(1) Met: The requirement is stated in active voice and uses defined terms without ambiguity; (2) Justification: It clearly specifies the system's behavior under a specific condition (high-speed internet). Verifiable—(1) Met: The requirement is verifiable as it includes a measurable outcome (loading within 3 seconds); (2) Justification: Performance can be tested with appropriate tools to measure load time. Complete—(1) Partially Met: The statement is a complete sentence but relies on the definition of “high-speed internet;” (2) Justification for Not Met: It depends on external definition which could vary, making the requirement potentially incomplete in some contexts. Functional, Performance, Interface—(1) Met: Covers performance by specifying load time; (2) Justification: Directly relates to how the system performs under given internet speed conditions.” As shown, the output can include suggestions for improving the clarity or verifiability of the requirement, adjustments to the technical descriptions, or additional test cases to further improve compliance.

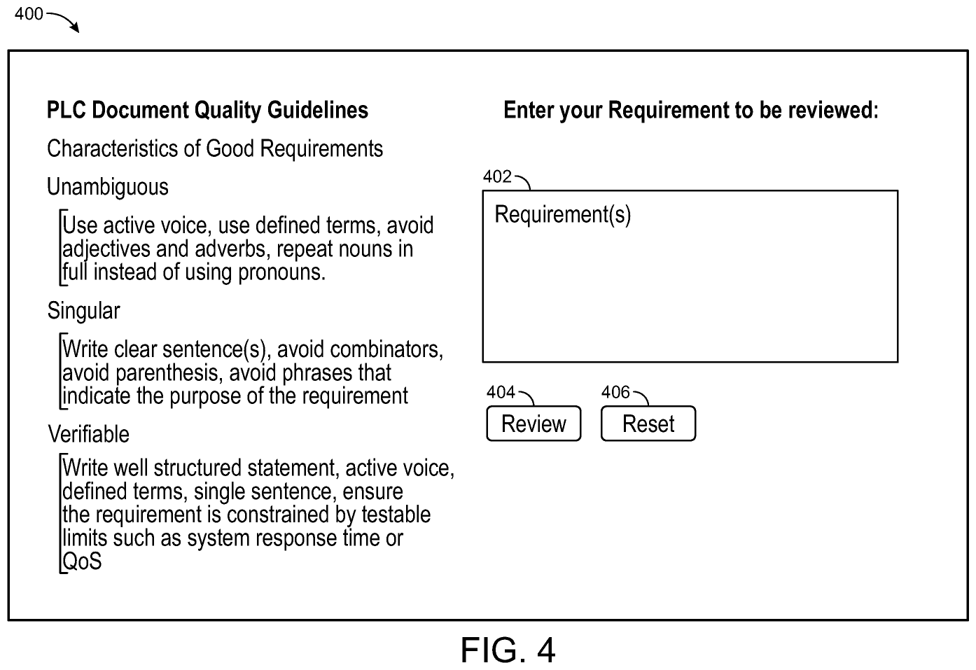

Referring now to FIG. 4A, an example illustration of a graphical user interface 400 for providing input to the large language model, in accordance with some embodiments of the present disclosure. As shown, the user operating a user device (e.g., client system 101) can input software requirements into the GUI 400. In some implementations, the graphical user interface (GUI) 400 can include interactive elements, such as a paragraph text field (402), and buttons (404, 406), configured for user engagement. For example, a paragraph text field 402 can be interacted with by the user typing or pasting software requirements for modeling by the large language model 116. In another example, button 404 can be selected by the user to submit the software requirements for review. In yet another example, button 406 can be selected by the user to reset the paragraph text field 402. Additionally, the GUI 400 can also include content to guide the user in selecting or providing “quality” or “good” software requirements.

For example, users can interact with the paragraph text field 402 by typing or pasting software requirements into it for processing by the large language model 116. In another example, button 404 allows users to submit these software requirements for review. In yet another example, button 406 can be used to reset the contents of the paragraph text field 402. Additionally, the GUI 400 can also feature content that assists users in selecting or providing high-quality software requirements. In some implementations, submitting the software requirements can be facilitated through an API. Before the requirements are inputted into the large language model 116, a prompt layer can be used to generate a prompt customized to the submitted software requirements. The customization can also include selecting a specific feedback level—such as predefined levels L0, L1, L2, L3 (feedback levels)—which can be used to specify the complexity of feedback during the prompt tuning process or in runtime.

In some implementations, a feedback response from the large language model 116 can be displayed in the GUI 400. This feedback can include an analysis of the provided software requirements, indicating whether they meet specific requirements and/or criteria such as clarity, verifiability, completeness, and consistency. For example, the feedback might highlight that a requirement like “The system should load web pages within 3 seconds when the user has a high-speed internet connection” meets the verifiability criterion but partially meets the completeness criterion due to the reliance on an ambiguous term like “high-speed internet.” The response can suggest modifications to improve precision, such as defining “high-speed internet” or specifying measurable outcomes. The feedback provided can then be used by the user to refine the requirements, iterating through multiple submissions until the software requirements align with the predefined requirements and criteria.

For example, the large language model 116 can process visual inputs, such as screenshots or other visualizations generated from the code. For example, a user can upload a screenshot of a graphical user interface (GUI) displaying a particular functionality, such as a login screen with multi-factor authentication, into the GUI 400. The large language model 116 can receive this visual input and the textual requirement “The system must authenticate users using multi-factor authentication.” The large language model 116 can provide feedback indicating whether the visual design implements the requirement, highlighting any discrepancies or suggesting improvements.

In another example, the large language model 116 can receive and process 3D models or CAD files as part of the input. For instance, a user can submit a CAD model of a user interface component, such as a dashboard, into the GUI 400. The large language model 116 can receive the CAD model and the requirement “The system must provide a user-friendly dashboard for monitoring system health.” The large language model 116 can provide feedback on the usability and compatibility of the design, suggesting modifications if necessary. The large language model 116 can process visualizations like flowcharts or architectural diagrams, using these as supplementary information to make a determination.

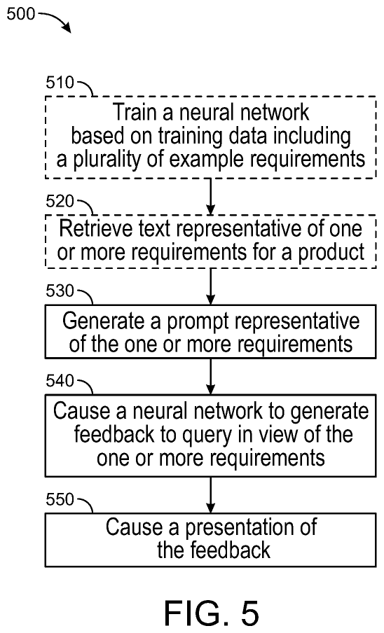

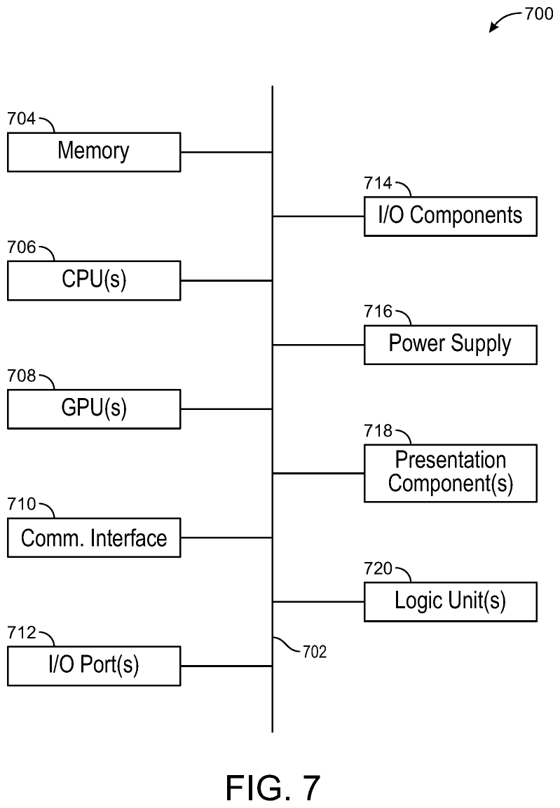

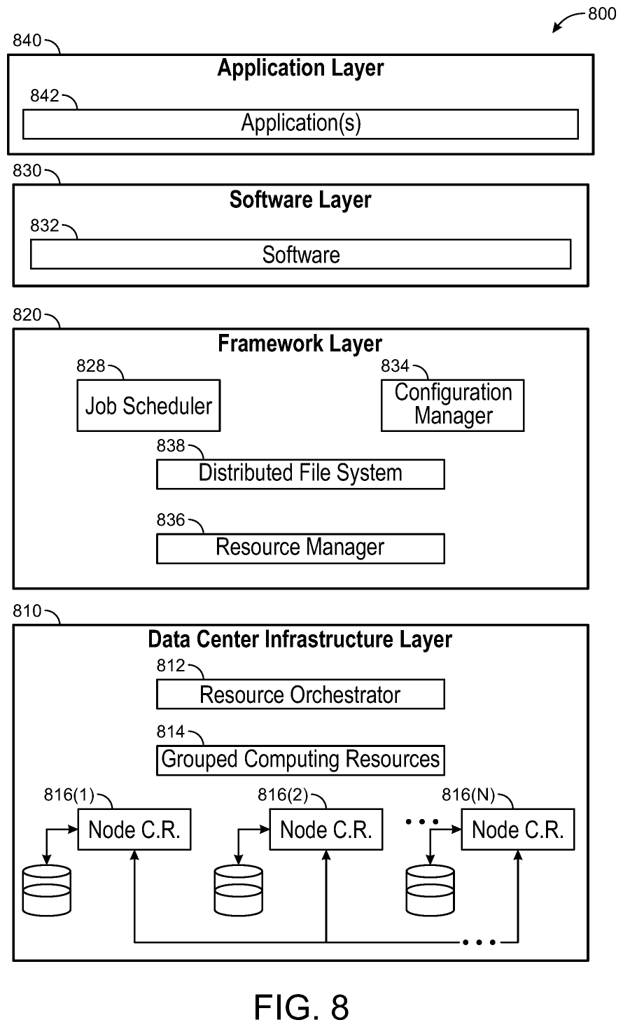

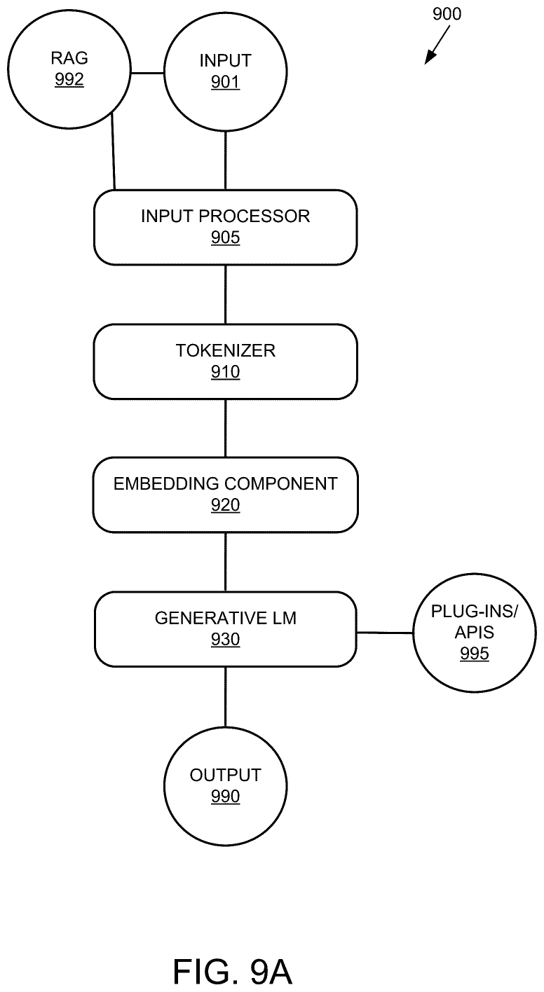

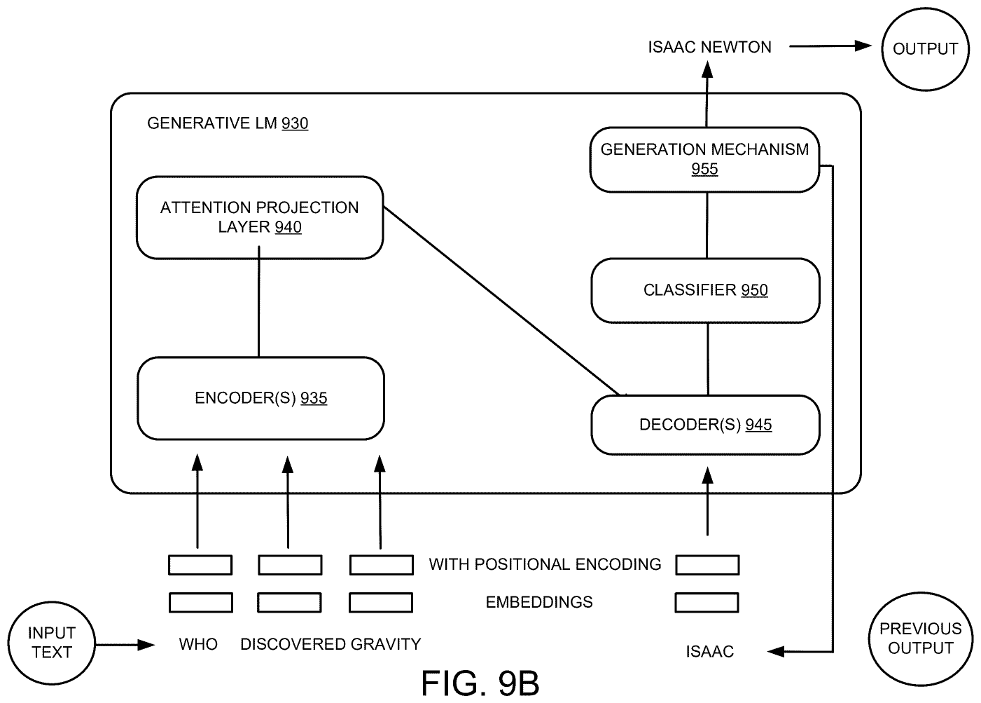

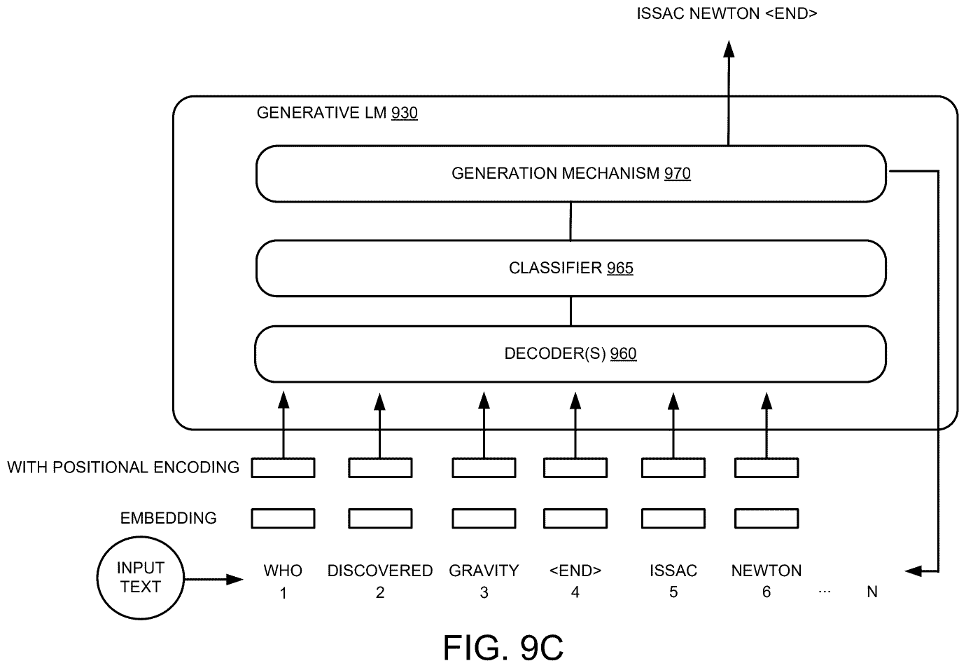

Now referring to FIG. 5, each block of method 500, described herein, includes a computing process that can be performed using any combination of hardware, firmware, and/or software. For instance, various functions can be carried out by a processor executing instructions stored in memory. The method can also be embodied as computer-usable instructions stored on computer storage media. The method can be provided by a standalone application, a service or hosted service (standalone or in combination with another hosted service), or a plug-in to another product, to name a few. In addition, method 500 is described, by way of example, with respect to the systems and architectures of FIG. 1 and FIG. 2. However, this method can additionally or alternatively be executed by any one system, or any combination of systems, including, but not limited to, those described herein. For example, in some implementations, the system and methods described herein may be implemented using one or more generative language models (e.g., as described in FIGS. 9A-9C), one or more computing devices (e.g., as described in FIG. 7), and/or one or more data centers (e.g., as described in FIG. 8).

FIG. 5 is a flow diagram showing a method 500 for automation of software requirement using language models, in accordance with some embodiments of the present disclosure. Various operations of the method 500 can be implemented by the same or different devices or entities at various points in time. For example, one or more first devices can implement operations relating to configuring and updating/training machine learning models, one or more second devices can implement operations relating to deployed and updated/trained machine learning models, and one or more third devices can implement operations relating to receive user inputs (e.g., software requirements). The one or more third devices can maintain the neural network models, or can access the neural network models using, for example and without limitation, APIs provided by the one or more first devices and/or the one or more second devices.

Various operations of method 500 can relate to the updating/training and implementation of large language models (LLMs) to validate and enhance the quality of requirement documents. Method 500 can integrate LLMs to perform automated reviews of quality requirement documents, identifying common errors, inconsistencies, and deviations from established guidelines, such as ambiguous language, contradictory statements, or missing information. Various operations of the method 500 can relate to content coherence, where the LLMs can assess the flow and logical structure of submitted documents. These LLMs of method 500 can identify requirements that can be difficult to understand and suggest modifications to improve readability and structure. In some implementations, language and grammar checks can be performed, correcting typographical, grammatical, and punctuation errors. Various operations of the method 500 can relate to consistency validation, where the LLMs can analyze the use of uniform terminology and style throughout software requirement documents. This operation can reduce confusion in technical and quality requirement documents. Compliance with industry or regulatory standards, such as the Easy Approach to Requirements Syntax (EARS) and standards from the International Council on Systems Engineering (INCOSE), can be facilitated through the LLMs' updated/training to verify adherence to these standards within the requirement documents.

Method 500 can also include operations that use the LLMs to suggest document enhancements by proposing alternative wordings, rephrasing sentences, or adding context. Keyword analysis can also be performed, where the LLMs can be updated/trained and implemented to check for the correct inclusion of keywords and phrases that can be important for accurately conveying specifications and expectations. Additionally, the operations of 500 can include cross-referencing the accuracy of references to other documents or standards. In some implementations, method 500 can incorporate user prompt tuning techniques to adapt the large language model to the specific task of reviewing software requirements. This can include updating/training one or more parameters known as prompts, which can be prepended to input text to guide the LLM towards generating outputs that are specific to the requirements.

Natural language allows for the expression of complex software functionalities and interactions but introduces significant challenges. Specifically, capturing precise and unambiguous software requirements through natural language is inherently difficult due to the variability and subtlety of human language. This complexity often leads to semantic and syntactic errors in the requirements, such as ambiguities or unclear expressions, which can result in software that fails to comply with necessary performance and safety standards. Additionally, the processing of these requirements to ensure they accurately reflect the intended functionality and compliance standards often demands extensive computational resources. This can limit the efficiency of requirement analysis and verification processes, such as in real-time or near real-time development environments. Furthermore, conventional systems that manage and interpret these requirements exhibit limitations in scalability and adaptability, making it difficult to maintain accuracy and relevance in rapidly changing technological landscapes. These challenges impede the effectiveness of systems in managing the complexities of software requirement specification and ultimately affect the quality and reliability of the software products developed.

The method 500, at block 510, includes updating/training a neural network based at least on training data including a plurality of example requirements. In some implementations, the training data can also include a plurality of examples of feedback corresponding to the examples of requirements and associated criteria. For example, a first example of feedback can indicate that a first example of requirements of the plurality of examples of requirements meets a first criterion of the one or more criteria. In this example, the first example of feedback can be “requirement is clear and precise”, which can indicate “the system must encrypt all stored user data using AES-256 encryption” (e.g., the first example of requirements) satisfies “specificity” (e.g., the first criterion). In another example, a second example of feedback can indicate that a second example of requirements of the plurality of examples of requirements does not meet the first criterion. In this example, the second example of feedback can be “requirement lacks specific details”, which can indicate “the system should encrypt data” (e.g., the second example of requirements) does not satisfy “specificity” (e.g., the first criterion). In yet another example, a third example of feedback can indicate that a third example of requirements of the plurality of examples of requirements meets a second criterion of the one or more criteria. In this example, the third example of feedback can be “requirement includes measurable goals”, which can indicate “the software must render 3D models at a minimum frame rate of 60 frames per second” (e.g., the third example of requirements) satisfies “verifiable” (e.g., the second criterion). In yet another example, a fourth example of feedback can indicate that a fourth example of requirements of the plurality of examples of requirements does not meet the second criterion. In this example, the fourth example of feedback can be “requirement is not verifiable”, which can indicate “the software should render 3D models at satisfactory frames per second,” (e.g., the fourth example of requirements) does not satisfy “verifiable” (e.g., the second criterion). As shown, diverse training data can be used to update/train the neural network.

In some implementations, the neural network can include one or more language models. For example, a language model can be a large language model updated/trained to assess clarity and compliance (e.g., criteria) in requirement documents. In another example, a large model can be a model updated/trained to identify and rectify ambiguities in technical documents. The one or more language models can be updated/trained using natural language processing (NLP) to model the one or more requirements and generate the feedback to the query. In some implementations, NLP can be used to update/train the language models by analyzing and synthesizing language patterns found in requirement texts and prompts. For example, NLP can identify key phrases and conditions that indicate compliance or lack thereof. In another example, NLP can adjust language model responses to improve precision and relevance in feedback. In some implementations, the generated feedback can be outputted to a user interface that allows developers to interactively refine software requirements. For example, a display or viewport of the user can be caused to present the feedback. Additionally, the generated feedback can be used to continue updating/training the language model by incorporating new examples and iterations.

In some implementations, prompt tuning can be used to update/train the neural network. For example, the configuration of the neural network can include performing prompt tuning of the neural network. Prompt tuning can include adjusting the model's attention mechanisms to better focus on the nuances of software requirement language. In some implementations, the one or more parameters can be the weights and biases of the neural network layers. The one or more parameters can be updated based on performance metrics derived from test results. For example, an annotation of the examples of requirements can be “requires clarification for ambiguity”. For example, an annotation of the examples of feedback can be “provides detailed actionable feedback”.

In some implementations, the neural network can include a transformer architecture which can transform the prompt representative of the one or more requirements and/or criteria (an/or a query, at least a portion of the software product, and so on) into the feedback in a human-readable format. That is, the transformer architecture can be a generative pre-trained transformer (GPT) type model that can generate feedback to the query based on the complexity and specificity of the input requirements, the one or more criteria, the query, and/or at least a portion of the software product. For example, the GPT of the neural network can fine-tune responses based on ongoing user interactions and feedback revisions.

Still referring to block 510, the training data can also include a plurality of feedback level examples corresponding with the plurality of examples of requirements and associated criteria, and the plurality of examples of feedback. The feedback level examples can be classified into L0, L1, L2, and L3 levels. For example, a feedback level can be “L0”, which can correspond with “simple requirement statements”. In another example, a feedback level can be “L1”, which can correspond with “moderately complex requirement statements”. In yet another example, a feedback level can be “L2” or “L3”, which can correspond with “highly technical and detailed requirements”. That is, the feedback level examples can be used in training to improve model sensitivity to different levels of requirement complexity.

In some implementations, the neural network updated/trained using a plurality of example requirements, a plurality of examples of feedback, a plurality of feedback level examples can be updated according to the type of software product or software development project. Additionally, the neural network can include a transformer architecture that can process input patterns. Furthermore, prompt tuning can be used to further update/train the neural network by refining the model's output to recognize between different levels of requirement clarity and specificity. Thus, training/updating of the neural network improves the model's performance in analyzing and suggesting improvements for software requirements.

The method, at block 520, includes retrieving text representative of one or more requirements for a product. The text can also be representative of one or more criteria, a query, and at least a portion of the software product. In some implementations, the text can be for a software product or application. For example, retrieving text can include parsing documents and extracting relevant requirement statements. Additionally, the text (or processed audio, or processed speech) can be draft software requirements for the software product or application. Block 520 can be executed at runtime after the neural network is updated/trained. In some implementations, block 530 can include the retrieving of block 520.

The method, at block 530, includes generating a prompt representative of the one or more requirements, the one or more criteria, a query, and at least a portion of the software product. In some implementations, the prompt can be generated based at least on one or more requirements for a software product and one or more criteria related to the one or more requirements. For example, generating the prompt can include selecting relevant compliance standards based on user-selected options.

In some implementations, the prompt can be representative of a query related to the software product, such as, but not limited to, functional validation (e.g., “Does the requirement ‘The system must authenticate users using multi-factor authentication’ meet the security standards?”), performance assessment (e.g., “Is the requirement ‘The system must respond to user inputs within 2 seconds under peak load conditions’ achievable with the current infrastructure?”), compliance checks (e.g., “Does the requirement ‘The system must backup data every 24 hours’ comply with industry best practices?”), usability evaluation (e.g., “Is the requirement ‘The system must provide a user-friendly dashboard for monitoring system health’ clear and implementable?”), and reliability verification (e.g., “Does the requirement ‘The system must maintain 99.99% uptime’ align with the expected service level agreements?”). In some implementations, the prompt can be selected responsive to an input indicative of the one or more requirements. That is, a user can define the specific requirements, queries, and portions of the software product to be applied to the text representative of the prompt. For example, an input indicative of the prompt can include user selections from a graphical user interface.

In some implementations, the query can be a relevant software validation such as, but not limited to, functional validation (e.g., “Does the requirement ‘The system must authenticate users using multi-factor authentication’ meet security best practices?”), performance assessment (e.g., “Can the requirement ‘The system must respond to user inputs within 2 seconds under peak load conditions’ be achieved with current system capabilities?”), compliance checks (e.g., “Does the requirement ‘The system must backup data every 24 hours’ adhere to industry standards?”), usability evaluation (e.g., “Is the requirement ‘The system must provide a user-friendly dashboard for monitoring system health’ clearly defined and feasible?”), and reliability verification (e.g., “Does the requirement ‘The system must maintain 99.99% uptime’ align with service level agreements?”). In some implementations, the query can be selected responsive to an input indicative of the one or more queries. That is, a user can select the specific queries to be applied to the text representative of the one or more software requirements. For example, an input indicative of the one or more queries can include user selections from a graphical user interface.

In some implementations, at least a portion of the software product can be an architectural component such as, but not limited to, a user authentication module (e.g., for security requirements), a database management subsystem (e.g., for performance and reliability requirements), an API gateway (e.g., for integration requirements), or a dashboard interface (e.g., for usability and design requirements). In some implementations, the portion of the software product can be selected responsive to an input indicative of the portion. That is, a user can specify the portion of the software product to be evaluated based on the requirements and queries. For example, an input indicative of the portion can include user selections from a graphical user interface.

In some implementations, the criteria can be a relevant software standard such as, but not limited to, Easy Approach to Requirements Syntax (EARS) (e.g., requirements specification standard), standards from the International Council on Systems Engineering (INCOSE) (e.g., systems engineering standards), ISO/IEC 12207 (e.g., software lifecycle processes), ISO/IEC 15504 (SPICE) (e.g., process assessment framework), ISO/IEC 25010 (SQuaRE) (e.g., quality requirements framework), IEEE 830 (e.g., requirements specification guidelines), IEEE 1016 (e.g., software design description guidelines), Capability Maturity Model Integration (CMMI) (e.g., process maturity framework), the Agile Manifesto (e.g., agile development principles), and/or ITIL (Information Technology Infrastructure Library) (e.g., IT service management best practices). In some implementations, the one or more criteria can be selected responsive to an input indicative of the one or more requirements for a software product and one or more criteria related to the one or more requirements. That is, a user can select the standard or standards to be applied to the text representative of the one or more software requirements. For example, an input indicative of the requirements and one or more criteria related to the one or more requirements can include user selections from a graphical user interface.

In some implementations, the prompt is further generated based on a feedback level. For example, the feedback level can cause the neural network to generate the feedback according to predefined compliance of the feedback level. The predefined compliance can be specific standards compliance. For example, the feedback level can be “Level 2” (e.g., predefined compliance) where the neural network generates the feedback to assess detailed compliance with specific standards. In some implementations, the neural networks outputs can analyze the prompt and text according to the inputted feedback level such that it provides detailed insights and recommendations for improvement. For example, when the text representing a software requirement (e.g., “The system shall handle up to 100,000 concurrent users”) and a prompt (e.g., “Assess scalability requirements”) is provided with feedback level L2, the neural network's feedback can be “Requirement meets scalability criteria but lacks specifics on hardware limitations”. In another example, when the text representing the same software requirement (e.g., “The system shall handle up to 100,000 concurrent users”) and the same prompt (e.g., “Assess scalability requirements”) is provided with feedback level L0, the neural network's feedback can be “Scalability requirement is clear”.

The method, at block 540, includes causing a neural network, to generate feedback to the query in view of the one or more requirements, the one or more criteria, and at least a portion of the software product. That is, the neural network can be trained and updated based at least on training data including a plurality of examples of requirements and associated criteria, and a plurality of examples of feedback corresponding to the examples of requirements and associated criteria. In some implementations, the neural network (trained/updated in block 510) can generate the feedback based on at least the text and the prompt. Additionally, the feedback can include at least one of an indication of a modification of the text or the modification of the text. That is, the feedback can be an output of the neural network (e.g., large language model) based on the model's training/updating and the instruction prompt generated and provided at block 530.

In some implementations, the indication of the modification of the text or the modification of the text satisfies the predefined compliance of the feedback level. That is, the generated feedback can propose specific revisions to meet compliance requirements. For example, the feedback can be “Consider specifying memory and processing power required to support 100,000 concurrent users”.

The method, at block 550, includes causing a presentation of the feedback. That is, the presentation can be in various formats such as textual summaries, annotated documents, visual highlights, and/or interactive dashboards. For example, method can include outputting the feedback regarding the one or more requirements. In some implementations, the feedback can be provided as a response to a client system. For example, an API can be used to transmit the feedback to the client system where it can be reviewed and acted upon by developers. In some implementations, causing a presentation can include displaying the feedback in various contexts (e.g., integrated development environments (IDEs), project management tools, or dashboards), sending reports via email to stakeholders, or generating alerts and notifications to prompt timely actions.

### Example Content Streaming System

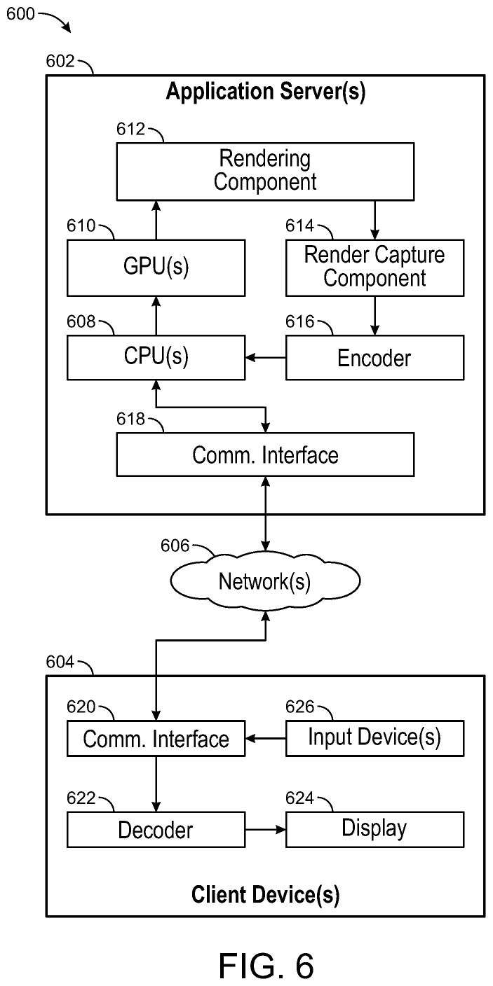

Now referring to FIG. 6, FIG. 6 is an example system diagram for a content streaming system 600, in accordance with some embodiments of the present disclosure. FIG. 6 includes application server(s) 602 (which can include similar components, features, and/or functionality to the example data processing system 110 of FIG. 1), client device(s) 604 (which can include similar components, features, and/or functionality to the example computing device 500 of FIG. 5), and network(s) 606 (which can be similar to the network(s) described herein). In some implementations of the present disclosure, the system 600 can be implemented to perform model training/updating and runtime operations. The application session can correspond to a game streaming application (e.g., NVIDIA GeFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types. For example, the system 600 can be implemented to receive input indicating one or more features of output to be generated using a neural network model, provide the input to the model to cause the model to generate the output, and use the output for various operations such as display or simulation operations.

In the system 600, for an application session, the client device(s) 604 can only receive input data in response to inputs to the input device(s), transmit the input data to the application server(s) 602, receive encoded display data from the application server(s) 602, and display the display data on the display 624. As such, the more computationally intense computing and processing is offloaded to the application server(s) 602 (e.g., rendering—in particular ray or path tracing—for graphical output of the application session is executed by the GPU(s) of the game server(s) 602). In other words, the application session is streamed to the client device(s) 604 from the application server(s) 602, thereby reducing the requirements of the client device(s) 604 for graphics processing and rendering.

For example, with respect to an instantiation of an application session, a client device 604 can be displaying a frame of the application session on the display 624 based on receiving the display data from the application server(s) 602. The client device 604 can receive an input to one of the input device(s) and generate input data in response, such as to provide prompts as input for generation of 3D avatars. The client device 604 can transmit the input data to the application server(s) 602 via the communication interface 620 and over the network(s) 606 (e.g., the Internet—Web2 or Web3), and the application server(s) 602 can receive the input data via the communication interface 618. The CPU(s) can receive the input data, process the input data, and transmit data to the GPU(s) that causes the GPU(s) to generate a rendering of the application session. For example, the input data can be representative of a movement or animation of a character of the user in a game session of a game application, firing a weapon, reloading, passing a ball, turning a vehicle, etc. The rendering component 612 can render the application session (e.g., representative of the result of the input data) and the render capture component 614 can capture the rendering of the application session as display data (e.g., as image data capturing the rendered frame of the application session). The rendering of the application session can include ray or path-traced lighting and/or shadow effects, computed using one or more parallel processing units-such as GPUs, which can further employ the use of one or more dedicated hardware accelerators or processing cores to perform ray or path-tracing techniques—of the application server(s) 602. In some implementations, one or more virtual machines (VMs)—e.g., including one or more virtual components, such as vGPUs, vCPUs, etc.—can be used by the application server(s) 602 to support the application sessions. The encoder 616 can then encode the display data to generate encoded display data and the encoded display data can be transmitted to the client device 604 over the network(s) 606 via the communication interface 618. The client device 604 can receive the encoded display data via the communication interface 620 and the decoder 622 can decode the encoded display data to generate the display data. The client device 604 can then display the display data via the display 624.

### Example Computing Device

FIG. 7 is a block diagram of an example computing device(s) 700 suitable for use in implementing some embodiments of the present disclosure. Computing device 700 can include an interconnect system 702 that directly or indirectly couples the following devices: memory 704, one or more central processing units (CPUs) 706, one or more graphics processing units (GPUs) 708, a communication interface 710, input/output (I/O) ports 712, input/output components 714, a power supply 716, one or more presentation components 718 (e.g., display(s)), and one or more logic units 720. In at least one embodiment, the computing device(s) 700 can include one or more virtual machines (VMs), and/or any of the components thereof can include virtual components (e.g., virtual hardware components). For non-limiting examples, one or more of the GPUs 708 can include one or more vGPUs, one or more of the CPUs 706 can include one or more vCPUs, and/or one or more of the logic units 720 can include one or more virtual logic units. As such, a computing device(s) 700 can include discrete components (e.g., a full GPU dedicated to the computing device 700), virtual components (e.g., a portion of a GPU dedicated to the computing device 700), or a combination thereof.

Although the various blocks of FIG. 7 are shown as connected via the interconnect system 702 with lines, this is not intended to be limiting and is for clarity only. For example, in some implementations, a presentation component 718, such as a display device, can be considered an I/O component 714 (e.g., if the display is a touch screen). As another example, the CPUs 706 and/or GPUs 708 can include memory (e.g., the memory 704 can be representative of a storage device in addition to the memory of the GPUs 708, the CPUs 706, and/or other components). In other words, the computing device of FIG. 7 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 7.

The interconnect system 702 can represent one or more links or busses, such as an address bus, a data bus, a control bus, or a combination thereof. The interconnect system 702 can be arranged in various topologies, including but not limited to bus, star, ring, mesh, tree, or hybrid topologies. The interconnect system 702 can include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 706 can be directly connected to the memory 704. Further, the CPU 706 can be directly connected to the GPU 708. Where there is direct, or point-to-point connection between components, the interconnect system 702 can include a PCIe link to carry out the connection. In these examples, a PCI bus need not be included in the computing device 700.

The memory 704 can include any of a variety of computer-readable media. The computer-readable media can be any available media that can be accessed by the computing device 700. The computer-readable media can include both volatile and nonvolatile media, and removable and non-removable media. By way of example, and not limitation, the computer-readable media can include computer-storage media and communication media.

The computer-storage media can include both volatile and nonvolatile media and/or removable and non-removable media implemented in any method or technology for storage of information such as computer-readable instructions, data structures, program modules, and/or other data types. For example, the memory 704 can store computer-readable instructions (e.g., that represent a program(s) and/or a program element(s), such as an operating system. Computer-storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, quantum memories, or any other medium which can be used to store the desired information and which can be accessed by computing device 700. As used herein, computer storage media does not include signals per se.

The computer storage media can embody computer-readable instructions, data structures, program modules, and/or other data types in a modulated data signal such as a carrier wave or other transport mechanism and includes any information delivery media. The term “modulated data signal” can refer to a signal that has one or more of its characteristics set or changed in such a manner as to encode information in the signal. By way of example, and not limitation, the computer storage media can include wired media such as a wired network or direct-wired connection, and wireless media such as acoustic, RF, infrared and other wireless media. Combinations of any of the above should also be included within the scope of computer-readable media.

The CPU(s) 706 can be configured to execute at least some of the computer-readable instructions to control one or more components of the computing device 700 to perform one or more of the methods and/or processes described herein. The CPU(s) 706 can each include one or more cores (e.g., one, two, four, eight, twenty-eight, seventy-two, etc.) that are capable of handling a multitude of software threads simultaneously. The CPU(s) 706 can include any type of processor, and can include different types of processors depending on the type of computing device 700 implemented (e.g., processors with fewer cores for mobile devices and processors with more cores for servers). For example, depending on the type of computing device 700, the processor can be an Advanced RISC Machines (ARM) processor implemented using Reduced Instruction Set Computing (RISC) or an x86 processor implemented using Complex Instruction Set Computing (CISC). The computing device 700 can include one or more CPUs 706 in addition to one or more microprocessors or supplementary co-processors, such as math co-processors.

In addition to or alternatively from the CPU(s) 706, the GPU(s) 708 can be configured to execute at least some of the computer-readable instructions to control one or more components of the computing device 700 to perform one or more of the methods and/or processes described herein. One or more of the GPU(s) 708 can be an integrated GPU (e.g., with one or more of the CPU(s) 706 and/or one or more of the GPU(s) 708 can be a discrete GPU. In embodiments, one or more of the GPU(s) 708 can be a coprocessor of one or more of the CPU(s) 706. The GPU(s) 708 can be used by the computing device 700 to render graphics (e.g., 3D graphics) or perform general purpose computations. For example, the GPU(s) 708 can be used for General-Purpose computing on GPUs (GPGPU). The GPU(s) 708 can include hundreds or thousands of cores that are capable of handling hundreds or thousands of software threads simultaneously. The GPU(s) 708 can generate pixel data for output images in response to rendering commands (e.g., rendering commands from the CPU(s) 706 received via a host interface). The GPU(s) 708 can include graphics memory, such as display memory, for storing pixel data or any other suitable data, such as GPGPU data. The display memory can be included as part of the memory 704. The GPU(s) 708 can include two or more GPUs operating in parallel (e.g., via a link). The link can directly connect the GPUs (e.g., using NVLINK) or can connect the GPUs through a switch (e.g., using NVSwitch). When combined together, each GPU 708 can generate pixel data or GPGPU data for different portions of an output or for different outputs (e.g., a first GPU for a first image and a second GPU for a second image). Each GPU can include its own memory, or can share memory with other GPUs.

In addition to or alternatively from the CPU(s) 706 and/or the GPU(s) 708, the logic unit(s) 720 can be configured to execute at least some of the computer-readable instructions to control one or more components of the computing device 700 to perform one or more of the methods and/or processes described herein. In embodiments, the CPU(s) 706, the GPU(s) 708, and/or the logic unit(s) 720 can discretely or jointly perform any combination of the methods, processes and/or portions thereof. One or more of the logic units 720 can be part of and/or integrated in one or more of the CPU(s) 706 and/or the GPU(s) 708 and/or one or more of the logic units 720 can be discrete components or otherwise external to the CPU(s) 706 and/or the GPU(s) 708. In embodiments, one or more of the logic units 720 can be a coprocessor of one or more of the CPU(s) 706 and/or one or more of the GPU(s) 708.

Examples of the logic unit(s) 720 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Image Processing Units (IPUs), Graphics Processing Clusters (GPCs), Texture Processing Clusters (TPCs), Streaming Multiprocessors (SMS), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 710 can include one or more receivers, transmitters, and/or transceivers that allow the computing device 700 to communicate with other computing devices via an electronic communication network, included wired and/or wireless communications. The communication interface 710 can include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 720 and/or communication interface 710 can include one or more data processing units (DPUs) to transmit data received over a network and/or through interconnect system 702 directly to (e.g., a memory of) one or more GPU(s) 708. In some implementations, a plurality of computing devices 700 or components thereof, which can be similar or different to one another in various respects, can be communicatively coupled to transmit and receive data for performing various operations described herein, such as to facilitate latency reduction.

The I/O ports 712 can allow the computing device 700 to be logically coupled to other devices including the I/O components 714, the presentation component(s) 718, and/or other components, some of which can be built in to (e.g., integrated in) the computing device 700. Illustrative I/O components 714 include a microphone, mouse, keyboard, joystick, game pad, game controller, satellite dish, scanner, printer, wireless device, etc. The I/O components 714 can provide a natural user interface (NUI) that processes air gestures, voice, or other physiological inputs generated by a user, such as to generate a prompt, image data, and/or video data. In some instances, inputs can be transmitted to an appropriate network element for further processing, such as to modify and register images. An NUI can implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 700. The computing device 700 can be include depth cameras, such as stereoscopic camera systems, infrared camera systems, RGB camera systems, touchscreen technology, and combinations of these, for gesture detection and recognition. Additionally, the computing device 700 can include accelerometers or gyroscopes (e.g., as part of an inertia measurement unit (IMU)) that allow detection of motion. In some examples, the output of the accelerometers or gyroscopes can be used by the computing device 700 to render immersive augmented reality or virtual reality.

The power supply 716 can include a hard-wired power supply, a battery power supply, or a combination thereof. The power supply 716 can provide power to the computing device 700 to allow the components of the computing device 700 to operate.

The presentation component(s) 718 can include a display (e.g., a monitor, a touch screen, a television screen, a heads-up-display (HUD), other display types, or a combination thereof), speakers, and/or other presentation components. The presentation component(s) 718 can receive data from other components (e.g., the GPU(s) 708, the CPU(s) 706, DPUs, etc.), and output the data (e.g., as an image, video, sound, etc.).

### Example Data Center

FIG. 8 illustrates an example data center 800 that can be used in at least one embodiments of the present disclosure, such as to implement the system 80 and/or the system 200 in one or more examples of the data center 800. The data center 800 can include a data center infrastructure layer 810, a framework layer 820, a software layer 830, and/or an application layer 840.

As shown in FIG. 8, the data center infrastructure layer 810 can include a resource orchestrator 812, grouped computing resources 814, and node computing resources (“node C.R.s”) 816(1)-816(N), where “N” represents any whole, positive integer. In at least one embodiment, node C.R.s 816(1)-816(N) can include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R.s from among node C.R.s 816(1)-816(N) can correspond to a server having one or more of the above-mentioned computing resources. In addition, in some implementations, the node C.R.s 816(1)-816(N) can include one or more virtual components, such as vGPUs, vCPUs, and/or the like, and/or one or more of the node C.R.s 816(1)-816(N) can correspond to a virtual machine (VM).

In at least one embodiment, grouped computing resources 814 can include separate groupings of node C.R.s 816 housed within one or more racks (not shown), or many racks housed in data centers at various geographical locations (also not shown). Separate groupings of node C.R.s 816 within grouped computing resources 814 can include grouped compute, network, memory or storage resources that can be configured or allocated to support one or more workloads. In at least one embodiment, several node C.R.s 816 including CPUs, GPUs, DPUs, and/or other processors can be grouped within one or more racks to provide compute resources to support one or more workloads. The one or more racks can also include any number of power modules, cooling modules, and/or network switches, in any combination.

The resource orchestrator 812 can configure or otherwise control one or more node C.R.s 816(1)-816(N) and/or grouped computing resources 814. In at least one embodiment, resource orchestrator 812 can include a software design infrastructure (SDI) management entity for the data center 800. The resource orchestrator 812 can include hardware, software, or some combination thereof.

In at least one embodiment, as shown in FIG. 8, framework layer 820 can include a job scheduler 828, a configuration manager 834, a resource manager 836, and/or a distributed file system 838. The framework layer 820 can include a framework to support software 832 of software layer 830 and/or one or more application(s) 842 of application layer 840. The software 832 or application(s) 842 can respectively include web-based service software or applications, such as those provided by Amazon Web Services, Google Cloud and Microsoft Azure. The framework layer 820 can be, but is not limited to, a type of free and open-source software web application framework such as Apache Spark™ (hereinafter “Spark”) that can utilize distributed file system 838 for large-scale data processing (e.g., “big data”). In at least one embodiment, job scheduler 828 can include a Spark driver to facilitate scheduling of workloads supported by various layers of data center 800. The configuration manager 834 can be capable of configuring different layers such as software layer 830 and framework layer 820 including Spark and distributed file system 838 for supporting large-scale data processing. The resource manager 836 can be capable of managing clustered or grouped computing resources mapped to or allocated for support of distributed file system 838 and job scheduler 828. In at least one embodiment, clustered or grouped computing resources can include grouped computing resource 814 at data center infrastructure layer 810. The resource manager 836 can coordinate with resource orchestrator 812 to manage these mapped or allocated computing resources.

In at least one embodiment, software 832 included in software layer 830 can include software used by at least portions of node C.R.s 816(1)-816(N), grouped computing resources 814, and/or distributed file system 838 of framework layer 820. One or more types of software can include, but are not limited to, Internet web page search software, e-mail virus scan software, database software, and streaming video content software.

In at least one embodiment, application(s) 842 included in application layer 840 can include one or more types of applications used by at least portions of node C.R.s 816(1)-816(N), grouped computing resources 814, and/or distributed file system 838 of framework layer 820. One or more types of applications can include, but are not limited to, any number of a genomics application, a cognitive compute, and a machine learning application, including training/updating or inferencing software, machine learning framework software (e.g., PyTorch, TensorFlow, Caffe, etc.), and/or other machine learning applications used in conjunction with one or more embodiments, such as to train, configure, update, and/or execute machine learning models.

In at least one embodiment, any of configuration manager 834, resource manager 836, and resource orchestrator 812 can implement any number and type of self-modifying actions based on any amount and type of data acquired in any technically feasible fashion. Self-modifying actions can relieve a data center operator of data center 800 from making possibly bad configuration decisions and possibly avoiding underutilized and/or poor performing portions of a data center.

The data center 800 can include tools, services, software or other resources to train/update one or more machine learning models (e.g., train/update machine learning models) or predict or infer information using one or more machine learning models (e.g., to generate a large language model) according to one or more embodiments described herein. For example, a machine learning model(s) can be trained/updated by calculating weight parameters according to a neural network architecture using software and/or computing resources described above with respect to the data center 800. In at least one embodiment, trained/updated or deployed machine learning models corresponding to one or more neural networks can be used to infer or predict information using resources described above with respect to the data center 800 by using weight parameters calculated through one or more training/updating techniques, such as but not limited to those described herein.

In at least one embodiment, the data center 800 can use CPUs, application-specific integrated circuits (ASICs), GPUs, FPGAs, and/or other hardware (or virtual compute resources corresponding thereto) to perform training/updating and/or inferencing using above-described resources. Moreover, one or more software and/or hardware resources described above can be configured as a service to allow users to train/update or perform inferencing of information, such as image recognition, speech recognition, or other artificial intelligence services.

### Example Network Environments

Network environments suitable for use in implementing embodiments of the disclosure can include one or more client devices, servers, network attached storage (NAS), other backend devices, and/or other device types. The client devices, servers, and/or other device types (e.g., each device) can be implemented on one or more instances of the computing device(s) 700 of FIG. 7—e.g., each device can include similar components, features, and/or functionality of the computing device(s) 700. In addition, where backend devices (e.g., servers, NAS, etc.) are implemented, the backend devices can be included as part of a data center 800, an example of which is described in more detail herein with respect to FIG. 8.

Components of a network environment can communicate with each other via a network(s), which can be wired, wireless, or both. The network can include multiple networks, or a network of networks. By way of example, the network can include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) can provide wireless connectivity.

Compatible network environments can include one or more peer-to-peer network environments—in which case a server cannot be included in a network environment—and one or more client-server network environments—in which case one or more servers can be included in a network environment. In peer-to-peer network environments, functionality described herein with respect to a server(s) can be implemented on any number of client devices.

In at least one embodiment, a network environment can include one or more cloud-based network environments, a distributed computing environment, a combination thereof, etc. A cloud-based network environment can include a framework layer, a job scheduler, a resource manager, and a distributed file system implemented on one or more of servers, which can include one or more core network servers and/or edge servers. A framework layer can include a framework to support software of a software layer and/or one or more application(s) of an application layer. The software or application(s) can respectively include web-based service software or applications. In embodiments, one or more of the client devices can use the web-based service software or applications (e.g., by accessing the service software and/or applications via one or more application programming interfaces (APIs)). The framework layer can be, but is not limited to, a type of free and open-source software web application framework such as that can use a distributed file system for large-scale data processing (e.g., “big data”).

A cloud-based network environment can provide cloud computing and/or cloud storage that carries out any combination of computing and/or data storage functions described herein (or one or more portions thereof). Any of these various functions can be distributed over multiple locations from central or core servers (e.g., of one or more data centers that can be distributed across a state, a region, a country, the globe, etc.). If a connection to a user (e.g., a client device) is relatively close to an edge server(s), a core server(s) can designate at least a portion of the functionality to the edge server(s). A cloud-based network environment can be private (e.g., limited to a single organization), can be public (e.g., available to many organizations), and/or a combination thereof (e.g., a hybrid cloud environment).

The client device(s) can include at least some of the components, features, and functionality of the example computing device(s) 700 described herein with respect to FIG. 7. By way of example and not limitation, a client device can be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, a holographic display, a biometric authentication device, a quantum computing device, a neuroenhancement headset, an augmented reality glasses, any combination of these delineated devices, or any other suitable device.

### Example Language Models

In at least some embodiments, language models, such as large language models (LLMs) and/or other types of generative artificial intelligence (AI) may be implemented. These models may be capable of understanding, summarizing, translating, and/or otherwise generating text (e.g., natural language text, code, etc.), images, video, computer aided design (CAD) assets, omniverse and/or metaverse file information (e.g., in USD format), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/etc. may be implemented for summarizing textual data, analyzing and extracting insights from data (e.g., textual, image, video, etc.), and generating new text/image/video/etc. in user-specified styles, tones, or formats. The LLMs of the present disclosure may be used exclusively for text processing, in embodiments, whereas in other embodiments, multimodal LLMs may be implemented to accept, understand, and/or generate text along with other types of content like images, audio, and/or video. For example, vision language models (VLMs), or more generally multimodal language models, may be implemented to accept image, video, audio, textual, 3D design (e.g., CAD), and/or other inputs data types and/or to generate or output image, video, audio, textual, 3D design, and/or other output data types.

Various types of LLM/VLM/etc. architectures may be implemented in various embodiments. For example, different architectures may be implemented that use different techniques for understanding and generating outputs-such as text, audio, video, image, etc. In some embodiments, LLM architectures such as recurrent neural networks (RNNs) or long short-term memory networks (LSTMs) may be used, while in other embodiments transformer architectures—such as those that rely on self-attention mechanisms—may be used to understand and recognize relationships between words or tokens. The language models of the present disclosure may include encoder and/or decoder block(s). For example, discriminative or encoder-only LLMs like BERT (Bidirectional Encoder Representations from Transformers) may be implemented for tasks that involve language comprehension such as classification, sentiment analysis, question answering, and named entity recognition. As another example, generative or decoder-only LLMs like GPT (Generative Pretrained Transformer) may be implemented for tasks that involve language and content generation such as text completion, story generation, and dialogue generation. LLMs that include both encoder and decoder components like T5 (Text-to-Text Transformer) may be implemented to understand and generate content, such as for translation and summarization. These examples are not intended to be limiting, and any architecture type-including but not limited to those described herein—may be implemented depending on the particular embodiment and the task(s) being performed using the model(s).

In various embodiments, the LLMs/VLMs/etc. may be trained using unsupervised learning, in which an LLM learns patterns from large amounts of unlabeled text/audio/video/image/etc. data. Due to the extensive training, in embodiments, the models may not require task-specific or domain-specific training. LLMs that have undergone extensive pre-training on vast amounts of unlabeled text data may be referred to as foundation models and may be adept at a variety of tasks like question-answering, summarization, filling in missing information, and translation. Some LLMs may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/etc. of the present disclosure may be implemented using various model alignment techniques. For example, in some embodiments, guardrails may be implemented to identify improper or undesired inputs (e.g., prompts) and/or outputs of the models. In some non-limiting embodiments, the guardrails implemented may be similar to those described in U.S. Pat. App. No. 18,304,341, filed on Apr. 20, 2023, the contents of which are hereby incorporated by reference in their entirety. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/etc. of the present disclosure may be less likely to output language/text/audio/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3^{rd} party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

FIG. 9A is a block diagram of an example generative language model system 900 suitable for use in implementing at least some embodiments of the present disclosure. In the example illustrated in FIG. 9A, the generative language model system 900 includes a retrieval augmented generation (RAG) component 992, an input processor 905, a tokenizer 910, an embedding component 920, plug-ins/APIs 995, and a generative language model (LM) 930 (which may include an LLM, a VLM, a multi-modal LM, etc.).

At a high level, the input processor 905 may receive an input 901 comprising text and/or other types of input data (e.g., audio data, video data, image data, sensor data (e.g., LiDAR, RADAR, ultrasonic, etc.), 3D design data, CAD data, universal scene descriptor (USD) data, etc.), depending on the architecture of the generative LM 930. In some embodiments, the input 901 includes plain text in the form of one or more sentences, paragraphs, and/or documents. Additionally or alternatively, the input 901 may include numerical sequences, precomputed embeddings (e.g., word or sentence embeddings), and/or structured data (e.g., in tabular formats, JSON, or XML). In some implementations in which the generative LM 930 is capable of processing multimodal inputs, the input 901 may combine text with image data, audio data, and/or other types of input data, such as but not limited to those described herein. Taking raw input text as an example, the input processor 905 may prepare raw input text in various ways. For example, the input processor 905 may perform various types of text cleaning to remove noise (e.g., special characters, punctuation, HTML tags, stopwords) from relevant textual content. In an example involving stopwords (common words that tend to carry little semantic meaning), the input processor 905 may remove stopwords to reduce noise and focus the generative LM 930 on more meaningful content. The input processor 905 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 992 may be used to retrieve additional information to be used as part of the input 901 or prompt. For example, in some embodiments, the input 901 may be generated using the query or input to the model (e.g., a question, a request, etc.) in addition to data retrieved using the RAG component 992. In some embodiments, the input processor 905 may analyze the input 901 and communicate with the RAG component 992 (or the RAG component 992 may be part of the input processor 905, in embodiments) in order to identify relevant text and/or other data to provide to the generative LM 930 as additional context or sources of information from which to identify the response, answer, or output 990, generally. For example, where the input indicates that the user is interested in a desired tire pressure for a particular make and model of vehicle, the RAG component 992 may retrieve—using a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 992 may retrieve a prior stored conversation history—or at least a summary thereof—and include the prior conversation history along with the current ask/request as part of the input 901 to the generative LM 930.

The tokenizer 910 may segment the (e.g., processed) text into smaller units (tokens) for subsequent analysis and processing. The tokens may represent individual words, subwords, characters, etc., depending on the implementation. Word-based tokenization divides the text into individual words, treating each word as a separate token. Subword tokenization breaks down words into smaller meaningful units (e.g., prefixes, suffixes, stems), enabling the generative LM 930 to understand morphological variations and handle out-of-vocabulary words more effectively. Character-based tokenization represents each character as a separate token, enabling the generative LM 930 to process text at a fine-grained level. The choice of tokenization strategy may depend on factors such as the language being processed, the task at hand, and/or characteristics of the training dataset. As such, the tokenizer 910 may convert the (e.g., processed) text into a structured format according to tokenization schema being implemented in the particular embodiment.

The embedding component 920 may use any known embedding technique to transform discrete tokens into (e.g., dense, continuous vector) representations of semantic meaning. For example, the embedding component 920 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 901 includes image data, the input processor 901 may resize the image data to a standard size compatible with format of a corresponding input channel and/or may normalize pixel values to a common range (e.g., 0 to 1) to ensure a consistent representation, and the embedding component 920 may encode the image data using any known technique (e.g., using one or more convolutional neural networks (CNNs) to extract visual features). In some implementations in which the input 901 includes audio data, the input processor 901 may resample an audio file to a consistent sampling rate for uniform processing, and the embedding component 920 may use any known technique to extract and encode audio features—such as in the form of a spectrogram (e.g., a mel-spectrogram). In some implementations in which the input 901 includes video data, the input processor 901 may extract frames or apply resizing to extracted frames, and the embedding component 920 may extract features such as optical flow embeddings or video embeddings and/or may encode temporal information or sequences of frames. In some implementations in which the input 901 includes multimodal data, the embedding component 920 may fuse representations of the different types of data (e.g., text, image, audio) using techniques like early fusion (concatenation), late fusion (sequential processing), attention-based fusion, etc.

The generative LM 930 and/or other components of the generative LLM system 900 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multimodal), RNNs, LSTMs, fusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 920 may apply an encoded representation of the input 901 to the generative LM 930, and the generative LM 930 may process the encoded representation of the input 901 to generate an output 990, which may include responsive text and/or other types of data.

As described herein, in some embodiments, the generative LM 930 may be configured to access or use—or capable of accessing or using—plug-ins/APIs 995 (which may include one or more plug-ins, application programming interfaces (APIs), databases, data stores, repositories, etc.). For example, for certain tasks or operations that the generative LM 930 is not ideally suited for, the model may have instructions (e.g., as a result of training, and/or based on instructions in a given prompt, such as those retrieved using the RAG component 992) to access one or more plug-ins/APIs 995 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 995 to the plug-in/API 995, the plug-in/API 995 may process the information and return an answer to the generative LM 930, and the generative LM 930 may use the response to generate the output 990. This process may be repeated—e.g., recursively—for any number of iterations and using any number of plug-ins/APIs 995 until an output 990 that addresses each ask/question/request/process/operation/etc. from the input 901 can be generated. As such, the model(s) may not only rely on its own knowledge from training on a large dataset(s) and/or from data retrieved using the RAG component 992, but also on the expertise or optimized nature of one or more external resources—such as the plug-ins/APIs 995.

FIG. 9B is a block diagram of an example implementation in which the generative LM 930 includes a transformer encoder-decoder. For example, assume input text such as “Who discovered gravity” is tokenized (e.g., by the tokenizer 910 of FIG. 9A) into tokens such as words, and each token is encoded (e.g., by the embedding component 920 of FIG. 99A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 935 of the generative LM 930.

In an example implementation, the encoder(s) 935 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 940 may convert the context vector into attention vectors (keys and values) for the decoder(s) 945.

In an example implementation, the decoder(s) 945 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 935, in an example transformer architecture, each token (e.g., word) flows through a separate path in the decoder(s) 945. During a first pass, the decoder(s) 945, a classifier 950, and a generation mechanism 955 may generate a first token, and the generation mechanism 955 may apply the generated token as an input during a second pass. The process may repeat in a loop, successively generating and adding tokens (e.g., words) to the output from the preceding pass and applying the token embeddings of the composite sequence with positional encodings as an input to the decoder(s) 945 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 935, except that it creates its queries from the layer below it and takes the keys and values (e.g., matrix) from the output of the encoder(s) 935.

As such, the decoder(s) 945 may output some decoded (e.g., vector) representation of the input being applied during a particular pass. The classifier 950 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 955 may select or sample a word or token based on a corresponding predicted probability (e.g., select the word with the highest predicted probability) and append it to the output from a previous pass, generating each word or token sequentially. The generation mechanism 955 may repeat the process, triggering successive decoder inputs and corresponding predictions until selecting or sampling a symbol or token that represents the end of the response, at which point, the generation mechanism 955 may output the generated response.

FIG. 9C is a block diagram of an example implementation in which the generative LM 930 includes a decoder-only transformer architecture. For example, the decoder(s) 960 of FIG. 9C may operate similarly as the decoder(s) 945 of FIG. 9B except each of the decoder(s) 960 of FIG. 9C omits the encoder-decoder self-attention layer (since there is no encoder in this implementation). As such, the decoder(s) 960 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 960. As with the decoder(s) 945 of FIG. 9B, each token (e.g., word) may flow through a separate path in the decoder(s) 960, and the decoder(s) 960, a classifier 965, and a generation mechanism 970 may use auto-regression to sequentially generate one token at a time until predicting a symbol or token that represents the end of the response. The classifier 965 and the generation mechanism 970 may operate similarly as the classifier 950 and the generation mechanism 955 of FIG. 9B, with the generation mechanism 970 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

The disclosure can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure can be practiced in a variety of system configurations, including hand-held devices, consumer electronics, general-purpose computers, more specialty computing devices, etc. The disclosure can also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” can include only element A, only element B, only element C, element A and element B, element A and element C, element B and element C, or elements A, B, and C. In addition, “at least one of element A or element B” can include at least one of element A, at least one of element B, or at least one of element A and at least one of element B. Further, “at least one of element A and element B” can include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
generate, based at least on one or more requirements for a software product and one or more criteria related to the one or more requirements, a prompt representative of the one or more requirements, the one or more criteria, a query, and at least a portion of the software product;
cause a neural network, to generate feedback to the query in view of the one or more requirements, the one or more criteria, and at least the portion of the software product, the neural network configured based at least on training data comprising a plurality of examples of requirements and associated criteria, and a plurality of examples of feedback corresponding to the examples of requirements and associated criteria; and
cause a presentation of the feedback.

2. The one or more processors of claim 1, wherein the feedback comprises at least one of an indication of a modification of text of the one or more requirements or the modification of text.

3. The one or more processors of claim 1, wherein the plurality of examples of feedback comprise at least one of:
a first example of feedback indicating that a first example of requirements of the plurality of examples of requirements meets a first criterion of the one or more criteria;
a second example of feedback indicating that a second example of requirements of the plurality of examples of requirements does not meet the first criterion;
a third example of feedback indicating that a third example of requirements of the plurality of examples of requirements meets a second criterion of the one or more criteria; or
a fourth example of feedback indicating that a fourth example of requirements of the plurality of examples of requirements does not meet the second criterion.

4. The one or more processors of claim 1, wherein the configuration of the neural network using the training data comprises a prompt tuning of the neural network, wherein the prompt tuning comprises updating one or more parameters of the neural network based at least on one or more annotations of the plurality of examples of requirements or the plurality of examples of feedback.

5. The one or more processors of claim 1, wherein the neural network comprises one or more language models, the one or more language models trained using natural language processing (NLP) to model the one or more requirements and generate the feedback.

6. The one or more processors of claim 1, wherein the neural network comprises a transformer architecture, the transformer architecture transforming the prompt representative of the one or more criteria into the feedback in a human-readable format.

7. The one or more processors of claim 1, wherein text of the one or more requirements is a first text, the prompt is a first prompt, and the feedback is a first feedback, and the one or more circuits are to:
retrieve a second text subsequent to output of the first feedback;
generate, based at least on the one or more requirements, a second prompt representative of the one or more criteria; and
cause the neural network, based at least on the first feedback, the second text, and the second prompt, to generate a second feedback regarding the second text.

8. The one or more processors of claim 1, wherein the prompt is further generated based at least on a feedback level, the feedback level causes the neural network to generate the feedback according to predefined compliance of the feedback level.

9. The one or more processors of claim 8, wherein the feedback satisfies the predefined compliance, and wherein the training data comprises a plurality of feedback level examples corresponding with the plurality of examples of requirements and the plurality of examples of feedback.

10. The one or more processors of claim 1, wherein the one or more processors is comprised in at least one of:
a system comprising one or more large language models (LLMs);
a system comprising one or more vision language models (VLMs);
a system for performing conversational AI operations;
a system for performing deep learning operations;
a system implemented using an edge device;
a system for generating synthetic data;
a system for performing simulation operations;
a system for performing collaborative content creation for 3D assets;
a system for performing digital twin operations;
a system for performing light transport simulation;
a control system for an autonomous or semi-autonomous machine;
a perception system for an autonomous or semi-autonomous machine;
a system incorporating one or more virtual machines (VMs);
a system implemented using a robot;
a system implemented at least partially in a data center; or
a system implemented at least partially using cloud computing resources.

11. A system comprising:
one or more processors to execute operations comprising:
generate, based at least on one or more requirements for a software product and one or more criteria related to the one or more requirements, a prompt representative of the one or more requirements, the one or more criteria, a query, and at least a portion of the software product;
cause a neural network, to generate feedback to the query in view of the one or more requirements, the one or more criteria, and at least the portion of the software product, the neural network configured based at least on training data comprising a plurality of examples of requirements and associated criteria, and a plurality of examples of feedback corresponding to the examples of requirements and associated criteria; and
cause a presentation of the feedback.

12. The system of claim 11, wherein the one or more processors executing the feedback comprises at least one of an indication of a modification of text of the one or more requirements or the modification of text.

13. The system of claim 11, wherein the plurality of examples of feedback comprise at least one of:
a first example of feedback indicating that a first example of requirements of the plurality of examples of requirements meets a first criterion of the one or more criteria;
a second example of feedback indicating that a second example of requirements of the plurality of examples of requirements does not meet the first criterion;
a third example of feedback indicating that a third example of requirements of the plurality of examples of requirements meets a second criterion of the one or more criteria; or
a fourth example of feedback indicating that a fourth example of requirements of the plurality of examples of requirements does not meet the second criterion.

14. The system of claim 11, wherein the configuration of the neural network using the training data comprises a prompt tuning of the neural network, wherein the prompt tuning comprises updating one or more parameters of the neural network based at least on one or more annotations of the plurality of examples of requirements or the plurality of examples of feedback.

15. The system of claim 11, wherein the neural network comprises one or more language models, the one or more language models trained using natural language processing (NLP) to model the one or more requirements and generate the feedback, and wherein the neural network comprises a transformer architecture, the transformer architecture transforming the prompt representative of the one or more criteria into the feedback in a human-readable format.

16. The system of claim 11, wherein text of the one or more requirements is a first text, the prompt is a first prompt, and the feedback is a first feedback, and the one or more processors executing the operations are to:
retrieve a second text subsequent to output of the first feedback;
generate, based at least on the one or more requirements, a second prompt representative of the one or more criteria; and
cause the neural network, based at least on the first feedback, the second text, and the second prompt, to generate a second feedback regarding the second text.

17. The system of claim 11, wherein the prompt is further generated based at least on a feedback level, the feedback level causes the neural network to generate the feedback according to predefined compliance of the feedback level.

18. The system of claim 11, wherein the system includes at least one of:
a system comprising one or more large language models (LLMs);
a system comprising one or more vision language models (VLMs);
a system for performing conversational AI operations;
a system for performing deep learning operations;
a system implemented using an edge device;
a system for generating synthetic data;
a system for performing simulation operations;
a system for performing collaborative content creation for 3D assets;
a system for performing digital twin operations;
a system for performing light transport simulation;
a control system for an autonomous or semi-autonomous machine;
a perception system for an autonomous or semi-autonomous machine;
a system incorporating one or more virtual machines (VMs);
a system implemented using a robot;
a system implemented at least partially in a data center; or
a system implemented at least partially using cloud computing resources.

19. A method, comprising:
generating, using one or more processors based at least on one or more requirements for a software product and one or more criteria related to the one or more requirements, a prompt representative of the one or more requirements, the one or more criteria, a query, and at least a portion of the software product;
causing, using the one or more processors, a neural network to generate feedback to the query in view of the one or more requirements, the one or more criteria, and at least the portion of the software product; and
causing, using the one or more processors, a presentation of the feedback.

20. The method of claim 19, wherein the feedback comprises at least one of an indication of a modification of text of the one or more requirements or the modification of text, and wherein the prompt is further generated based at least on a feedback level, the feedback level causes the neural network to generate the feedback according to predefined compliance of the feedback level.
